(19) United States
(12) Patent Application Publication
(10) Pub. No.: US 2025/0360568 A1
(43) Pub. Date: Nov. 27, 2025

(54) OPTICS ASSEMBLY

(71) Applicant: VulcanForms Inc., Devens, MA (US)

(72) Inventors: Raghav Aggarwal, Dracut, MA (US); Joseph D. Sandt, Evanston, IL (US); Michael von Dadelszen, Merrimack, NH (US)

(73) Assignee: VulcanForms Inc., Devens, MA (US)

(21) Appl. No.: 19/216,071

(22) Filed: May 22, 2025

Related U.S. Application Data
(60) Provisional application No. 63/650,961, filed on May 23, 2024.

(51) Int. Cl. B22F 12/41; B22F 12/70; B33Y 30/00

(52) U.S. Cl. CPC B22F 12/41; B22F 12/70; B33Y 30/00

(57) ABSTRACT

An additive manufacturing system includes an optics assembly. The optics assembly includes a plurality of serially arranged and connected modules. Each module of the plurality of serially arranged and connected modules includes a module housing. Each module housing includes a first end portion and a second end portion. The first end portion includes a first module fitting and the second end portion includes a second module fitting. The first and second module fittings are each configured to form a respective adjustable mechanically interlocking connection with an adjacent module of the optics assembly. At least one module of the plurality of serially arranged and connected modules includes at least one optical component disposed within the associated module housing. The at least one optical component is configured to interact with at least one laser beam as the at least one laser beam passes through the optics assembly.

### RELATED APPLICATIONS

This application claims priority under 35 U.S.C. § 119(e) to U.S. Provisional Application No. 63/650,961, filed May 23, 2024, the content of which is incorporated herein by reference in its entirety for all purposes.

### FIELD

Disclosed embodiments are generally related to optics assemblies and related methods of use.

### BACKGROUND

Additive manufacturing systems employ various techniques to create three-dimensional objects from two-dimensional layers. After a layer of precursor material is deposited onto a build surface, a portion of the layer may be fused through exposure to one or more energy sources to create a desired two-dimensional geometry of solidified material within the layer. Next, the build surface may be indexed, and another layer of precursor material may be deposited. For example, in conventional systems, the build surface may be indexed downwardly by a distance corresponding to a thickness of a layer. This process may be repeated layer-by-layer to fuse many two-dimensional layers into a three-dimensional object.

### SUMMARY

In some embodiments, an optics assembly for an additive manufacturing system may comprise an optical fiber module, wherein at least one optical fiber is disposed within the optical fiber module. The optical fiber module may have a gas flow inlet configured to receive a flow of gas. The optics assembly may further comprise at least one optics module, each optics module comprising an optics module housing and at least one optical component disposed in the optics module housing. Each optical component may be configured to interact with at least one laser beam from the at least one optical fiber as the at least one laser beam passes through the optics assembly. The optics assembly may further comprise an optics shield module having a gas flow outlet. The optics assembly may further comprise a gas flow path extending from the gas flow inlet of the optical fiber module to the gas flow outlet of the optics shield module. The gas flow path may be configured to allow the flow of gas to pass through each of the optical fiber module, the optics shield module, and each optics module of the at least one optics module.

In some embodiments, a method for additive manufacturing may comprise directing a flow of gas into an optical fiber module of an optics assembly. The optical fiber module may comprise at least one optical fiber configured to produce at least one laser beam. The method may further comprise directing the flow of gas into at least one optics module of the optics assembly. Each optics module of the at least one optics module may comprise at least one optical component disposed within the optics module. The at least one optical component may be configured to interact with at least one laser beam from the at least one optical fiber as the at least one laser beam passes through the optics assembly. The method may further comprise directing the flow of gas around each optical component of the at least one optical component. The method may further comprise directing the flow of gas into an optics shield module of the optics assembly. The optics shield module may include a debris shield configured to inhibit particulate matter from entering the optics assembly. The method may further comprise directing the flow of gas around the debris shield, and directing the flow of gas out of the optics shield module towards a build surface of an additive manufacturing system.

In some embodiments, an additive manufacturing system may comprise an optics assembly. The optics assembly may include a plurality of serially arranged and connected modules, each module of the plurality of serially arranged and connected modules including a module housing. Each module housing may comprise a first end portion and a second end portion. The first end portion may include a first module fitting and the second end portion may include a second module fitting. The first module fitting and the second module fitting may each be configured to form a respective adjustable mechanically interlocking connection with an adjacent module of the optics assembly. At least one module of the plurality of serially arranged and connected modules may include at least one optical component disposed within the associated module housing, and the at least one optical component may be configured to interact with at least one laser beam as the at least one laser beam passes through the optics assembly.

In some embodiments, a method for assembling an optics assembly of an additive manufacturing system may comprise aligning a first module fitting of an optics module of the optics assembly with a second module fitting of a first adjacent module of the optics assembly. The first module fitting of the optics assembly may be disposed at a first end portion of the optics module. The method may further comprise forming a first adjustable mechanically interlocking connection between the first module fitting of the optics module and the second module fitting of the first adjacent module, and aligning a second module fitting of the optics module with a first module fitting of a second adjacent module. The second module fitting of the optics module may be disposed at a second end portion of the optics module. The method may further comprise forming a second adjustable mechanically interlocking connection between the second module fitting of the optics module and the first module fitting of the second adjacent module.

In some embodiments, an optics assembly of an additive manufacturing system may comprise at least one optics module. Each optics module may include an optics module housing, at least one optical component disposed within the optics module housing, and an optics mount configured to retain the at least one optical component in the optics module housing. The at least one optical component may be configured to interact with at least one laser beam as the at least one laser beam passes through the optics assembly. The optics mount may comprise a reference feature disposed within the optics module housing, and a resilient member configured to press the at least one optical component against the reference feature in response to compression applied to the resilient member. The optics mount may further comprise a reflective shield disposed between the resilient member and the at least one optical component. The reflective shield may be configured to reflect stray light away from the resilient member.

In some embodiments, a method for additive manufacturing may comprise retaining at least one optical component against a reference feature within an optics assembly by pressing a resilient member against the at least one optical component. The method may further comprise passing at least one laser beam through the optics assembly, and interacting with the at least one laser beam using the at least one optical component as the at least one laser beam passes through the optics assembly. The method may additionally include reflecting stray light away from the resilient member using a reflective shield disposed between the resilient member and the at least one optical component.

In some embodiments, an additive manufacturing system may comprise an optics assembly, which may include an optics assembly housing, and at least one optical component disposed within the housing. The at least one optical component may be configured to interact with at least one laser beam as the at least one laser beam passes along a beam path through the optics assembly. The optics assembly may further comprise a cooling module. The cooling module may comprise a cooling module housing forming a portion of the optics assembly housing, and a beam block disposed within the module housing along the beam path. The beam block may include an aperture sized and shaped to allow the at least one laser beam to pass through the beam block in a first direction, and at least one surface configured to divert stray light energy traveling in at least one second direction different from the first direction. The cooling module may further include a heat sink configured to absorb at least a portion of the stray light energy from the beam block, and at least one insulator disposed between the heat sink and the cooling module housing. The at least one insulator may be configured to thermally isolate the module housing from the heat sink.

In some embodiments, a method of additive manufacturing may comprise directing at least one laser beam along a beam path in a first direction from a proximal end portion of an optics assembly toward a distal end portion of an optics assembly and toward at least one layer of a precursor material disposed on a build plate. The method may further include diverting stray light energy traveling in a second direction different from the first direction using at least one surface of a beam block, and absorbing at least a portion of the stray light energy diverted by the beam block into a heat sink. The method may further comprise thermally isolating a housing in which the beam block and heat sink are disposed from heat energy absorbed by the heat sink.

In some embodiments, an additive manufacturing system may comprise an optics assembly including an optics assembly housing having a proximal end portion and a distal end portion. The optics assembly may extend in a longitudinal direction from the proximal end portion to the distal end portion. The optics assembly may include at least one optical component disposed in the optics assembly housing, the at least one optical component configured to interact with at least one laser beam as the at least one laser beam passes through the optics assembly. The optics assembly may further comprise a first support attached to a proximal portion of the optics assembly housing. The first support may be constrained in the longitudinal direction relative to the optics assembly housing. The optics assembly may further comprise a second support attached to the distal portion of the optics assembly housing. The distal portion of the optics assembly housing may be unconstrained in the longitudinal direction relative to the second support. The optics assembly may further comprise at least two struts. Each strut of the at least two struts may be attached to and extend between the first support and the second support in the longitudinal direction.

In some embodiments, a method for additive manufacturing may include directing at least one laser beam through a housing of an optics assembly, and heating the optics assembly housing as a result of the at least one laser beam passing through the housing. The optics assembly housing may extend in a longitudinal direction. The method may further include constraining a transverse deflection of a distal portion of the optics assembly housing relative to a proximal portion of the optics assembly housing while allowing a longitudinal deflection of the distal portion relative to the proximal portion, the transverse and longitudinal deflections resulting from thermal expansion of the optics assembly housing in response to the heating.

In some embodiments, an optics shield module for an optics assembly of an additive manufacturing system may comprise a first gas flow plenum at a proximal end portion of the nozzle module. The first gas flow plenum may include one or more first plenum gas inlets. The optics shield module may further comprise a first gas flow passage in fluid communication with the first gas flow plenum volume via one or more first gas flow passage inlets. The first gas flow passage may extend from the proximal end portion to an intermediate portion of the optics shield module, and may have at least a first gas flow outlet adjacent to the intermediate portion. The optics shield module may further include a second gas flow plenum in fluid communication with the first gas flow passage via the first gas flow outlet, and a second gas flow passage in fluid communication with the second gas flow plenum volume via one or more second gas flow passage inlets. The second gas flow passage may extend from the intermediate portion to a distal end portion of the optics shield module, and may have a gas flow outlet at the distal end portion. The second gas flow passage may be configured to direct a flow of gas out of the optics shield module through the gas flow outlet and towards a build plate of the additive manufacturing system.

In some embodiments, a method for additive manufacturing may comprise directing at least one laser beam in a distal direction along a beam path extending from a proximal end portion of an optics assembly toward a distal end portion of the optics assembly. The optics assembly may include an optics shield module at the distal end portion. The method may further comprise directing a flow of gas through the optics shield module at least partially in the distal direction along the beam path to resist movement of particulate matter in a proximal direction opposite the distal direction. Directing the flow of gas through the optics shield module may comprise directing the flow of gas into a first gas flow plenum, directing the flow of gas from the first gas flow plenum volume into a first gas flow passage, directing the flow of gas from the first gas flow passage into a second gas flow plenum, directing the flow of gas from the second gas flow plenum into a second gas flow passage, and directing the flow of gas out of the optics assembly through a gas flow outlet disposed at a distal end of the second gas flow passage.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

Other advantages and novel features of the present disclosure will become apparent from the following detailed description of various non-limiting embodiments of the disclosure when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a schematic representation of an optics assembly in an additive manufacturing system, according to some embodiments;

FIG. 2 shows a flow of gas through an optics assembly, according to some embodiments;

FIG. 3 shows a module of an optics assembly, according to some embodiments;

FIG. 4A shows a pair of module fittings, according to some embodiments;

FIG. 4B shows a pair of module fittings, according to some embodiments;

FIG. 5 shows a top view of an optics module of an optics assembly, according to some embodiments;

FIG. 6 shows a cross-sectional view of an optics module of an optics assembly, according to some embodiments;

FIG. 7 shows a cross-sectional view of a cooling module of an optics assembly, according to some embodiments;

FIG. 8A depicts potential effects of thermal expansion on an optics assembly according to some embodiments;

FIG. 8B depicts an optics assembly having supports and struts, according to some embodiments;

FIG. 9 shows a top view of an optics shield module of an optics assembly, according to some embodiments;

FIG. 10 shows a first cross-sectional view of an optics shield module of an optics assembly, according to some embodiments;

FIG. 11 shows a second cross-sectional view of an optics shield module of an optics assembly, according to some embodiments;

FIG. 12 shows a bottom perspective view of an optics shield module of an optics assembly, according to some embodiments; and

FIG. 13 shows a flow chart illustrating a method of manufacturing an optics assembly, according to some embodiments.

### DETAILED DESCRIPTION

Some additive manufacturing systems may include one or more laser energy sources configured to emit one or more laser beams to fuse the precursor material. In some embodiments, each beam may create a respective laser spot (i.e., a respective pixel) on the build surface. The term “build surface” may refer to a topmost layer of precursor material, or to the underlying build plate if no precursor material has been deposited yet. Further, in some embodiments, each laser energy source may be coupled to a respective optical fiber to direct a respective laser beam to a desired location, such as an optical fiber module of an optics assembly as described herein.

In some such systems, various optical components may be used to influence one or more parameters of the laser beam(s). For example, some systems may include an optics assembly comprising various optical fibers, lenses (which may be individual lenses, lens arrays, microlenses, microlens arrays, and/or combined macrolenses), windows, apertures, mirrors, filters, and/or other optical components to interact with the laser beam(s), for example to achieve one or more desired optical qualities in the laser beam(s). In some systems, the function of an optical component may be affected by the position and condition of an optical component. For example, an optical component which is misaligned, out of position, damaged, contaminated, or which otherwise deviates from an intended state may cause undesired and/or unintended changes in the laser beam(s). For example, deviations in the optical component(s) may affect a focus, direction, angle, shape, distortion, power density profile, or other parameters of the laser beam(s), which may affect the performance of the additive manufacturing system.

More specifically, the function of an optical component and/or the parameters of a laser beam may be sensitive to the presence of particulate matter or other contaminants. For example, where particulate matter accumulates or deposits on an optical component, the particulates may damage the component and/or interfere with the component's optical functions. Additionally, where particulate matter is allowed to accumulate in a free space between optical components, the particulates may interfere with the propagation of the laser beam(s) through the free space. The presence of such particulates may affect the focus, shape, distortion, direction, power density profile, and/or other characteristic(s) of the laser beam(s). As will be appreciated, such effects may be induced by the presence of particulate matter either on an optical component or a surface thereof, or in any other optically active space.

As will be appreciated, there may be many sources of particulate matter in an additive manufacturing system. For example, particulate matter may originate from or be part of a powdered precursor material. Such particulate matter may include ejecta and other contamination produced and/or released during fusion of the precursor material, for example from a melt pool formed by the incidence of laser energy on the build surface. In some applications, such ejecta and other contamination may include individual powder particles, partially fused powder particles, droplets of molten material, cooled molten droplets, gasified material particles, and/or fumes. In some applications, particulates may also be generated from certain procedures, components, and/or materials used in manufacturing and/or assembling the additive manufacturing system itself. For example, manufacturing methods that require threaded connections for fasteners or other components may generate particulates during threading. Other types of joining arrangements (e.g., friction fittings, snap fittings, etc.) between hard or rigid materials (e.g., metals, plastics, composites, etc.) may also generate particulates.

Further to the above, the effects from particulate matter discussed herein may also be caused by gaseous matter. For example, the assembly and operation of an additive manufacturing system may result in various vapors, fumes, smoke, aerosols, plasmas, etc., which may cause deposits or accumulations to form on an optical component or in an optical space. In some systems, other gaseous matter (e.g., volatile organic compounds, or VOCs) may be released (i.e., off-gassed) from various materials such as plastics, polymers, elastomers, epoxies, adhesives, and/or other materials used in the system. Thus, it will be appreciated that any of the terms “particulate matter,” “particulates,” “contaminants,” or other similar terms used herein may refer to the gaseous matter, ejecta, particulate matter, and any other appropriate contaminating matter which may contribute to the issues discussed herein, as the present disclosure is not limited to addressing issues relating to only a single form of contaminating matter.

In view of the particulate-related issues discussed above, the inventors have recognized and appreciated the benefits of inhibiting particulate matter from entering and/or being generated within an optics assembly and/or an optically active space in the optics assembly. In particular, the inventors have recognized and appreciated the benefits of procedures, components, and/or materials which reduce and/or may eliminate the generation of particulate matter. For example, in some embodiments, an optics assembly may be manufactured as a plurality of serially arranged modules, which may be connected in ways which reduce and/or may eliminate generation of particulate matter during their construction and assembly. In some embodiments, each module may be configured to perform a desired function in the optics assembly. Depending on the application, an optics assembly may include one or more of the following modules: an optical fiber module configured to house one or more optical fibers configured to direct laser energy into the optics assembly; an optics module configured to retain one or more optical components of the optics assembly; a cooling module configured to retain one or more energy management components of the optics assembly; an optics shield module configured to prevent particulate matter from entering the optics assembly; and/or an interface module configured to provide a desired spacing between two adjacent modules.

As noted above, optical components which are misaligned or out of position may affect the quality of the laser beam(s) in the system. Thus, the inventors have recognized and appreciated the benefits of an optics assembly including adjustable mechanically interlocking connections between two or more modules of the optics assembly. In some embodiments, an adjustable mechanically interlocking connection may allow adjustments to a position, an orientation, or both a pose and an orientation (i.e., a pose) of one module relative to another, such that the alignment/positioning of optical components within the modules may be controlled to produce a desired beam quality. Thus, in some embodiments, adjustable mechanically interlocking connections may be formed between two or more modules. For example, in some embodiments, a portion of a first module (such as a tongue or a collar, as described further below) may be inserted into a portion of an adjacent module (such as a groove or a receptacle). In some such embodiments, sufficient clearance may be left between the portion of the first module and the portion of the adjacent module to allow a relative position and/or orientation of the modules to be adjusted while maintaining the connection. For example, a pose of a first module may be adjusted while a tongue of the first module is inserted into a groove of the adjacent module.

As further noted above, the inventors have recognized and appreciated the benefits of avoiding generation of particulate matter during construction of the optics assembly. Accordingly, in some embodiments, a mechanically interlocking connection may be formed without the use of threaded fasteners or other joining arrangements which may generate particulates. Further, a mechanically interlocking connection may form a seal between the modules to prevent particulate matter from entering the optics assembly. Thus, in addition to facilitating adjustment and fixation of a position/orientation of the module(s), a mechanically interlocking connection as disclosed herein may protect against the effects of particulate matter in the optics assembly. In some embodiments, a mechanically interlocking connection formed using an adhesive material may provide the desired seal while allowing the position/orientation of the module(s) to be adjusted, and/or while also avoiding or reducing the generation of particulate matter during formation. For example, an epoxy or other adhesive material may be deposited into the groove into which the tongue is inserted, and there may be a period of time before the epoxy cures/solidifies. Thus, before the epoxy or other curable adhesive has cured, the relative positioning of the modules may be adjusted within the clearance space discussed above. In various embodiments, the adhesive material may be deposited at any appropriate time. For example, in some embodiments, the adhesive material may be deposited before the tongue is inserted into the groove, or before two adjacent modules are otherwise connected (e.g., before a collar is inserted into a receptacle). In some embodiments, the adhesive material may be deposited after the tongue is inserted into the groove, or after two adjacent modules are otherwise connected (e.g., after a collar is inserted into a receptacle), such that the adhesive may be deposited into a gap, channel, or other space between the two adjacent modules. Further, in some embodiments, an epoxy or other adhesive material may be selected to exhibit low off-gassing properties to prevent issues arising from generation of particulate matter. Depending on the application, a low off-gassing adhesive may be any appropriate one-or two-part adhesive, epoxy, sealant, resin, bonding agent, glue, or other suitable material having low off-gassing properties. In some embodiments, a low off-gassing adhesive may comprise a bisphenol A diglycidyl ether (DGEBA) resin, a bisphenol F diglycidyl ether (DGEBF) resin, and/or any other appropriate adhesive material. Further, in some embodiments, an adhesive material may be selected based on an adhesive strength, a cure time, one or more fluid properties, one or more thermal properties (e.g., thermal conductivity), and/or any other appropriate properties in addition to the low off-gassing properties discussed herein.

Further to the above, adjusting the relative position(s) of the modules may facilitate alignment of the optical components in an optics assembly. In some embodiments, these adjustments may be performed as part of a laser calibration process, such as a rotational laser calibration. In some such processes, one or more laser beams may be directed through the optics assembly, and the optics assembly may be rotated about its longitudinal axis to produce a circular laser path on a calibration surface. One or more characteristic of the circular laser path may be evaluated, such as the size or eccentricity of the circular laser path. In some embodiments, the modules (at least one of which may include an optical component whose position and alignment may influence the circular laser path) may be aligned based at least in part on the evaluation of the circular laser path, for example to achieve a desired characteristic of the circular laser path. Although rotational laser calibration processes are described herein, it will be appreciated that other laser calibration processes may be used in addition to or instead of rotational laser calibration.

Further to the low-particulate assembly processes described above, the inventors have recognized and appreciated that particulate-related issues may additionally or alternatively be addressed using one or more gas flow arrangements to prevent contaminants such as particulate and/or gaseous matter from entering the optics assembly, and/or to remove particulate matter which has entered the optics assembly. In some embodiments, a flow of gas may flow through at least a portion of each module of an optics assembly, for example to pressurize the optics assembly or optical space relative to a surrounding environment (i.e., to provide a positive pressure environment in the optical space). In some embodiments, the flow of gas may be configured to entrain particulate matter in the optical space and carry the particulate matter out of the optical space and/or away from one or more optical components, for example to prevent or inhibit the deposition of particulate matter on the optical component(s). In some embodiments, the flow of gas may pass through one or more filters prior to or upon entering the optics assembly to remove particulate matter from the flow of gas. For example, in some embodiments, a gas flow inlet of the optics assembly may include one or more filters configured to remove contaminants from a flow of gas entering the optics assembly or an optical space therein. Depending on the application, a gas filter may comprise any appropriate filter, including a high-efficiency particulate air (HEPA) filter, ultra-low penetration air (ULPA) filters, electrostatic filters, and/or any other appropriate filter. Further, a gas filter of an optics assembly may comprise more than one filter. For example, in some embodiments, a gas filter may include two or more filters arranged in series.

Further, the optics assembly may be configured to direct the flow of gas through the various optical modules of an assembled optical assembly to provide localized entrainment of contaminants to each optical module and/or each optical component of the optics assembly, for example by passing by each optical component. In some embodiments, an optical component may be retained in the optics assembly (or a module thereof) using an optics mount which may be configured to allow the flow of gas past and/or around the optical component. For example, an optics mount may include one or more bypass channels configured to permit the flow of gas to pass therethrough. In some embodiments, the one or more bypass channels may provide fluid communication between a first volume and a second volume of a module, such that the flow of gas may be directed between the first and second volumes. The first and second volumes, in some embodiments, may be separated by one or more optical component and/or an optics mount retaining the optical component(s).

Further to the above, a flow of gas through an optics assembly may be configured to inhibit contaminants from entering the optics assembly. For example, some optics assemblies may include a distal aperture through which the laser beam(s) may exit the optics assembly. During operation, the distal aperture may be positioned near the build surface and/or a melt pool formed by the laser beam(s). Thus, a flow of gas or a portion thereof may be directed through the distal aperture to inhibit the ejecta and other contaminants described above from entering the optics assembly via the distal aperture. For example, a distal end portion of an optics assembly may include a nozzle, tube, or other gas flow passage configured to direct a flow of gas towards the build surface and/or away from the optical space and/or the optics assembly.

In some embodiments, the distal end portion of some optics assemblies may further include one or more optical components. For example, in order to alleviate problems associated with back reflection, scattering, and/or other optical effects at the melt pool, an optics assembly may include an optical component configured to induce a desired angle of incidence between the laser beam(s) and the build surface. As an example, a deflection optical component (also referred to herein as simply a “deflection optic”) may be included at a distal end portion of an optics assembly to offset the laser beam(s) prior to incidence on the build surface, and/or to adjust an incident angle of the laser beam(s) on the build surface. In some embodiments, the distal positioning of a deflection optic may subject the deflection optic to ejecta released from the melt pool.

Additionally or alternatively, in some embodiments, an optics assembly may include a component at the distal end portion that is configured to protect one or more optical components of the optics assembly from ejecta and/or other particulate matter. For example, some optics assemblies may include a debris shield at a distal end portion to prevent ejecta/particulates from entering the optics assembly through the distal end portion. In some embodiments, the debris shield may be an optically transparent component that is configured to allow the laser beam(s) to pass therethrough without altering the characteristics of the beam(s). In some embodiments, a debris shield may further be configured to be removed and replaced, for example when sufficient ejecta has deposited on the debris shield to begin affecting the beam quality.

Further to the above, some optics assemblies may include both a deflection optic and a debris shield. The inventors have recognized that, in some such assemblies, even when a debris shield is positioned distally relative to the deflection optic (i.e., between the deflection optic and the build surface), the deflection optic may still be exposed to more ejecta and/or other particulates than other portions of the optics assembly (e.g., other optical components positioned proximally relative to the deflection optic).

In view of the above, the inventors have recognized and appreciated the benefits of a distal end portion of an optics assembly which is configured to provide localized entrainment and removal of contaminants for portions of an optical assembly for both a deflection optic and a debris shield. In some embodiments, an optics shield module may be included at the distal end portion, and may include the deflection optic and the debris shield. The optics shield module may further include a respective gas flow passage associated with each of the deflection optic and the debris shield. Each gas flow passage may be configured to allow a flow of gas therethrough to inhibit ejecta from moving towards the associated optical component. In some embodiments, the gas flow passages may be provided in a serial arrangement, such that the flow of gas may enter one passage after exiting the other. Furthermore, in some embodiments, each of the deflection optic and the debris shield may be retained in the optics shield module by a mount configured to allow the flow of gas to pass by each optical component. For example, a deflection optic mount and/or a debris shield mount may include one or more bypass channels, as described above

Additionally, in some embodiments, the above-noted gas flows for entrainment and removal of contaminants may be provided by a gas flow passage or a portion thereof associated with a gas flow plenum located upstream of the gas flow passage. The plenum may be configured to quiesce the flow of gas, for example by controlling or slowing a gas flow velocity. In this regard, a gas flow plenum may be configured to facilitate a steady uniform flow condition at, near, or through an entrance of the gas flow passage, or to provide one or more other gas flow characteristics (e.g., a laminar flow condition). In embodiments which include a first gas flow passage and a second gas flow passage, each gas flow passage may be associated with a respective plenum. In some such embodiments, a second plenum associated with the second gas glow passage may counteract undesirable flow conditions which may be present in the flow exiting the first gas flow passage. For example, a velocity of the flow exiting the first gas flow passage may exceed a velocity required to produce a steady uniform flow condition at the entrance into the second gas flow passage. As the entrainment capacity of the second gas flow passage may be influenced by the uniformity of the flow at the entrance, the inventors have recognized that a second gas flow plenum prior to the second gas flow passage may improve the entrainment capacity of the flow through the second gas flow passage.

In addition to the issues arising from particulate matter discussed above, optical issues and/or beam quality issues may also arise due to heat generation and absorbance in the different portions of an optics assembly. As will be appreciated, heat may be imparted into an optics assembly from various sources, including light energy from the laser beam(s) which may be absorbed as heat energy by the optics assembly or a portion thereof. In some applications, optical components subject to heating, and thus changes in operating temperature, may undergo thermal lensing (i.e., a change in a refractive index and/or other optical property of the component) during operation. Such thermal lensing may affect the focus, shape, distortion, direction, angle, power density profile, and/or other characteristic(s) of the laser beam(s). Additionally or alternatively, thermal expansion of various components in an optics assembly may cause the alignment and/or positioning of the optical component(s) to change. For example, expansion of a mount or a housing in which an optical component is retained may change the alignment and/or positioning of an optical component relative to other optical components. Thus, thermal expansion may further affect the focus, shape, distortion, direction, angle, power density profile, and/or other characteristic(s) of the laser beam(s). Further, in some applications, thermal expansion may be non-uniform. For example, one side of an optics assembly may receive more heat than another side, resulting in greater expansion on one side than the other. This may cause a thermally-induced bending of the assembly. Such changes in alignment/positioning resulting from non-uniform thermal expansion of the optics assembly may further affect the focus, shape, distortion, direction, angle, power density profile, and/or other characteristic(s) of the laser beam(s).

In view of the above, the inventors have recognized and appreciated the benefits of removing heat from an optics assembly that is generated by operation/emission of the laser beam(s) from the optics assembly and/or components thereof. In some embodiments, an optics assembly may include one or more components and/or modules configured to manage stray light and/or heat energy imparted to the optics assembly from the laser beam(s). For example, an optics assembly may include one or more energy management components such as a beam block, a heat sink, a cooling channel, an insulator, and/or other heat management features.

In some embodiments, an optics assembly or a cooling module thereof may include a heat sink disposed along a portion of a length of a beam path and/or at least partially within an optical space. In some embodiments, a heat sink may at least partially surround a portion of the beam path, and/or may be disposed around a periphery or perimeter of the optical space. In some embodiments, a heat sink may be disposed inside of a housing, and may be arranged coaxially with the housing. Additionally, a heat sink may include one or more surfaces configured to absorb light energy and/or heat energy incident thereon. In some embodiments, the one or more surfaces may be particularly configured to absorb light energy within a range of wavelengths including one or more wavelengths of the laser beam(s), and/or within a range of wavelengths including one or more wavelengths of stray light energy (e.g., back reflected light, scattered light, and others). In various embodiments, the surface(s) may include a surface material, a surface treatment, and/or a surface finish configured to absorb light and/or heat. For example, in some embodiments, the surface may include a black anodized surface finish (e.g., black anodized aluminum), a black optical coating or foil, and/or any other appropriate surface configuration for absorbing light. In some embodiments, a heat sink may be formed from any appropriate coated or uncoated material for partially or completely absorbing, reflecting, and/or deflecting light energy, including copper, gold, steel, aluminum, and/or any other appropriate material or combination of materials, including materials having an absorbing coating such as an optical black coating (e.g., Acktar Black Coating), and/or materials having a reflective coating (e.g., a gold coating).

Additionally or alternatively, an optics assembly or a cooling module thereof may include a beam block disposed along a beam path and/or within an optical space of an optics assembly, and may include one or more apertures to allow the laser beam(s) to pass through the beam block in a first direction along the beam path. In some embodiments, the first direction may be from a proximal end portion of the optics assembly towards a distal end portion. For example, in some embodiments, the laser beam(s) may propagate from an optical fiber module at a proximal end portion of the optics assembly to an optics shield module at a distal end portion. Thus, the laser beam(s) may pass through the beam block from a proximal side of the beam block to a distal side of the beam block. The beam block may further include one or more surfaces configured to absorb or deflect light energy traveling in one or more directions different from the first direction. In various embodiments, the surface may include a surface material, a surface treatment, or a surface finish configured to absorb and/or deflect light energy. For example, in some embodiments, the surface may include a black anodized surface finish (e.g., black anodized aluminum), a black optical coating or foil, and/or any other appropriate surface configuration for absorbing light. Additionally or alternatively, in some embodiments, the surface may include an anodized surface finish, a reflective coating or foil (e.g., copper, gold, steel, or other reflective material), and/or any other appropriate surface configuration for reflecting or deflecting light. In some embodiments, a beam block may be formed from any appropriate coated or uncoated material for partially or completely absorbing, reflecting, and/or deflecting light energy, including copper, gold, steel, aluminum, and/or any other appropriate material or combination of materials, including materials having an absorbing coating such as an optical black coating (e.g., Acktar Black Coating, produced by Acktar Ltd., of Kiryat Gat, Israel), and/or materials having a reflective coating (e.g., a gold coating).

Further to the above, the inventors have recognized and appreciated the benefits of a beam block including two or more surfaces configured to deflect light energy to a common location or area. For example, a first surface of the beam block may be disposed on a proximal side of the beam block, and may be configured to deflect light traveling in a first direction (i.e., from an area proximal to the beam block) toward a heat sink. Additionally or alternatively, a second surface of the beam block may be disposed on a distal side and/or within the aperture of the beam block, and may be configured to deflect light traveling in a second direction toward the heat sink. The inventors have recognized that some such embodiments may facilitate more efficient cooling of the optics assembly, in that a single heat sink may be sufficient to absorb the energy deflected toward the common location or area from the both the first direction (e.g., the proximal side of the beam block) and the second direction (e.g., the distal side of the beam block). Thus, some such arrangements may enable the use of a single common heat sink for the optics assembly rather than, for example, a series of individual heat sinks disposed along a length of the optics assembly. Of course, it will be appreciated that a single common heat sink is not required for all embodiments, as optics assemblies according to the present disclosure may include any appropriate number of heat sinks in any appropriate arrangement while still retaining one or more of the benefits described herein.

The inventors have recognized that the quantity or proportion of stray light deflected and/or absorbed by a beam block may be influenced by the positioning of the beam block within the optical space relative to the laser beam(s). Accordingly, the inventors have appreciated the benefits of positioning an aperture of a beam block at a location selected based on one or more parameters of the beam(s). In some embodiments, a beam block may be positioned such that an aperture is located at a telecentric cross-over point of the beam(s). Such arrangements may allow the aperture to be smaller than arrangements in which the aperture is located elsewhere, as the beam(s) may have a smaller cross-sectional area at the telecentric cross-over point than other points along the beam path. As will be appreciated, a smaller aperture may increase the amount and/or proportion of stray light energy deflected and/or absorbed by the beam block.

Additionally or alternatively, a heat sink may include or be in thermal contact with one or more cooling channels configured to carry a flow of fluid. The flow(s) of fluid may be configured to absorb heat energy from the heat sink, and to carry the absorbed heat energy away from the heat sink, away from the optics assembly, and/or out of the optical space. In some embodiments, the cooling channel(s) may be cooperatively formed by the heat sink and a housing in which the heat sink is disposed (e.g., a housing of a cooling module or a housing of an optics assembly). For example, in some embodiments, an interior portion of a housing may cooperate with an exterior portion of a heat sink mounted within the housing to form one or more cooling channels, such that the flow(s) through the cooling channel(s) may provide cooling to both the heat sink and the housing. This may result in reduced changes in temperatures in the optical assembly during operation of the system. Thus, the inventors have recognized and appreciated that such cooling arrangements may reduce heating and thermal expansion of the housing and/or other portions of the optics module(s) and/or other components of an optical assembly which may correspondingly reduce thermal lensing, misalignment, and defocusing of the optical assembly associated with larger changes in temperature.

In some embodiments, one or more cooling channels may be disposed around a perimeter or periphery of the heat sink. Additionally or alternatively, in some embodiments, one or more cooling channels may extend at least partially in a first direction (i.e., a longitudinal direction/along a longitudinal axis of the optics assembly). In some embodiments, one or more cooling channels may be formed in a spiral arrangement, extending around a perimeter of the heat sink while also extending in a first direction.

Furthermore, the inventors have recognized and appreciated the benefits of including a cooling flow configured to provide greater cooling in one area of the optics assembly and/or heat sink than in another area. In this regard, the inventors have recognized that some portions along a length of an optics assembly and/or along a length of a heat sink thereof may be subjected to higher levels of heat. For example, an area surrounding a beam block may receive more heat/light energy as a result of the energy deflected by the beam block. Thus, a heat sink absorbing energy from the beam block may experience a maximum temperature in the area surrounding the beam block. The inventors have also recognized that the temperature of the cooling fluid may be at a minimum near an inlet of a cooling channel (i.e., before the cooling fluid has absorbed substantial heat), and at a maximum near the outlet (i.e., after the fluid has absorbed substantial heat). Importantly, the inventors have further recognized that the cooling capacity of the cooling fluid may be influenced by the temperature difference between the fluid and the heat sink. Thus, in some embodiments, a cooling channel may be fluidly coupled to a fluid inlet in an area adjacent to a beam block, and to a fluid outlet in an area spaced apart from the beam block. In some embodiments, the coincidence of the minimum temperature of the cooling fluid with the maximum temperature of the heat sink may result in a maximum temperature difference between the fluid and the heat sink. This may improve the cooling capacity in the area of the beam block, where the need for cooling may be higher in view of the increased heat imparted to the area.

Further to the above, the inventors have recognized and appreciated the benefits of providing thermal insulation between a heat sink and another portion of an optics assembly. For example, in some embodiments, a heat sink may be mounted in an internal portion of a housing and may be insulated from the housing using one or more insulating components. In some embodiments, one or more insulators may be disposed between the housing and the heat sink, such that the heat sink is spaced apart and/or separated from the housing by the insulator. The inventors have recognized and appreciated that some such insulating arrangements may alleviate thermal expansion of the housing, thereby facilitating the maintenance of a desired alignment and/or positioning of the optical components during operation of the system. In various embodiments, an insulator may comprise an elastic, rubber, polymer, composite, or other insulating material. For example, appropriate insulating materials may exhibit a desired thermal resistivity or thermal conductivity. In various applications, a material having any appropriate thermal resistivity may be selected based on any appropriate parameters of a given application, including a maximum power level of the laser beam(s), an expected maximum energy flux into the insulator, a desired durability or life expectancy of the insulator, and/or any other considerations appropriate for selecting the thermal resistivity and/or other properties of the insulator material. In some embodiments, a heat sink may be disposed inside of a housing, and may be arranged coaxially with the housing. In some such embodiments, an insulator may be formed as a gasket or an O-ring disposed around a perimeter of a heat sink (e.g., between an external portion of the heat sink and an internal portion of the housing). Additionally, in some embodiments, an insulator may be disposed in a channel formed in the heat sink or the housing.

In some embodiments, the energy management arrangements described herein (i.e., the heat sink, the beam block, the cooling channels, the insulators, etc.) may be configured to maintain a maximum temperature of the optics assembly within a particular range of a desired maximum temperature. For example, the surface finishes (e.g., absorbent and/or reflective surface finishes), the cooling flow parameters (e.g., location(s), flow rate(s), direction(s) cooling fluid properties, etc.), surface curvatures (e.g., reflective beam block surface curvatures), aperture parameters (e.g., location(s) and size(s) of the aperture(s) in the beam block(s)) may be selected to cooperatively maintain a maximum temperature within a desired range. In various embodiments, the optics assembly may be configured to maintain the maximum temperature to within 5° C., 1° C., 0.5° C., 0.25° C., or any other appropriate range of the desired maximum temperature.

Further, with respect to the particulate-related issues discussed above, the inventors have recognized that, in mounting a heat sink and/or a beam block within an optics assembly or module thereof, particulates may be generated from contact between the heat sink/beam block and a housing of the optics assembly, or from movement of the heat sink/beam block against the housing (e.g., sliding a metal surface of the heat sink/beam block against a metal surface of the housing). Thus, the inventors have recognized and appreciated the benefits of a heat sink and/or a beam block which may be mounted within a housing using processes, components, and/or materials which may result in reduced, or substantially no, generation of particulate matter. In some embodiments, a heat sink and/or beam block may be retained within a housing using one or more components which may allow for movement of the heat sink/beam block within the housing without generation of particulates. For example, in some embodiments, a resilient component may be disposed between a heat sink and a housing, such that the heat sink and housing are spaced apart by the resilient component. In some embodiments, the resilient component may be configured to allow the heat sink to be translated and/or rotated within the housing without contacting the housing, for example to prevent metal-to-metal contact or other particulate-generating contact between the heat sink and the housing while the heat sink is translated and/or rotated into a desired position and/or orientation. Further, in some embodiments, the resilient component may be configured to thermally insulate the housing from the heat sink as described above. For example, in some embodiments, the resilient member may comprise an insulator as described above. In various embodiments, a resilient component may comprise an elastomer, polymer, composite, and/or any other sufficiently elastic material configured to provide slidable contact between the heat sink and the housing, and may be formed as a gasket or an O-ring disposed around a perimeter of a heat sink (e.g., between an external portion of the heat sink and an internal portion of the housing). Additionally, in some embodiments, a resilient component may be disposed in a channel formed in the heat sink or the housing.

Further in view of the heat-related issues above, the inventors have additionally recognized and appreciated the benefits of constraining certain relative movements of one or more portions of the optics assembly which may result from thermal expansion, while allowing certain other relative movements resulting from thermal expansion. For example, in some embodiments, a bending of a second portion relative to a first may be constrained (for example, to maintain an alignment of the optical components), while an elongation of the second portion may be permitted (for example, to avoid over-constraining the assembly). Thus, in some embodiments, the second portion of the optics assembly may be permitted to expand and/or deflect relative to a first portion along a first direction of the optics assembly, but may be constrained in a second direction. For example, a distal portion may be permitted to expand in a longitudinal direction relative to a proximal portion, but constrained in a transverse direction. In some embodiments, a first support may be included at the first portion of the assembly, and a second support may be included at the second portion. Two or more struts may attach to and extend between the first support and the second support in a longitudinal direction of the optics assembly. The first support may be constrained relative to the proximal portion of the assembly in both the longitudinal and transverse directions, while the second support may be constrained relative to the distal portion of the assembly in only the transverse direction. The struts may be rigid, and may be configured to undergo relatively little thermal expansion, such that the second support is constrained relative to the proximal portion of the assembly by virtue of the struts and the first support. Thus, by constraining a transverse deflection of the distal portion relative to the second support, bending of the optics assembly may be resisted. In some embodiments, expansion and/or deflection of the distal portion of the optics assembly may be permitted, for example to avoid over-constraining the system and/or to relieve thermal stresses and/or strains.

The inventors have further recognized that the flow of gas discussed above in relation to the particulate-related issues may provide heat-related benefits as well. In some embodiments, the flow of gas may additionally or alternatively be configured to remove heat from the optical space and/or optics assembly. For example, some optics assemblies may include one or more sections configured to cause recirculation in the flow of gas to facilitate convective cooling of an area or structure adjacent to the recirculation area. In some such embodiments, an optics assembly may be configured to cause recirculation in one or more areas adjacent to an optical component or other component of an optics assembly to provide localized convective cooling to the component. As will be appreciated from the above, in some embodiments, the flow of gas may be configured to both to provide both localized cooling and localized entrainment benefits to each optical component/module. In some embodiments, the bypass channel(s) described herein may be configured to cause recirculation in the flow of gas in an area adjacent to the optical component. For example, one or more bypass channels of an optics mount may be sized and shaped to permit only a first portion of a flow of gas to pass therethrough, thereby causing a second portion of the flow of gas to recirculate prior to passing through the bypass channel(s). Additionally, in some embodiments, the bypass channel(s) may be sized and shaped to control and/or regulate a pressure of the flow. As will be appreciated, an optics mount and/or optical component may fail under pressure that exceeds a threshold pressure, resulting in the mounted component being dislodged and/or damaged. Thus, the inventors have recognized and appreciated that bypass channel(s) may be configured to maintain a pressure on the optics mount below the threshold pressure, while also providing the cooling and/or entrainment benefits discussed above.

Further to the above, the inventors have recognized and appreciated that the heat and contamination related problems discussed herein can interact with one another to compound the negative effects on beam quality. For example, particulates or other contamination on an optical component can increase heat absorbed into the material, leading to further thermal lensing, thermal expansion, and other detrimental effects. Additionally or alternatively, imparting greater heat to an off-gassing material can cause increased off-gassing, leading to further depositions and/or accumulations on optical components.

The inventors have further recognized and appreciated that both the heat and particulate related problems discussed above may become more disruptive to an additive manufacturing system as the power delivered through the system's laser(s) increases. For example, a lower-power laser system may not generate enough heat to produce sufficient thermal expansion or sufficient thermal lensing to materially alter the quality of a laser beam or the quality of a part built by the system. Similarly, a lower-power system may be less sensitive to the presence of particulates, as a lower-power laser may not damage a contaminated optical component as quickly or as severely. By contrast, in some of the systems disclosed herein, the power levels may be such that heat- and/or contaminant-related problems may significantly disrupt the proper operation of the system.

It should be appreciated that “stray light,” “stray light energy,” and similar terms as used herein may refer to scattered, reflected, back scattered, back reflected, refracted, diffuse light or laser energy, as well as light at wavelengths other than those delivered by the laser energy sources propagating away or towards one or more laser energy sources. In some instances, the inventors have appreciated that the source of stray light may also include second (and third, etc.) harmonics of the laser light, stimulated Brillouin scattering, Raman scattering, four wave mixing tones and/or other optical phenomena generated in the optical fibers, as well as any interactions of the laser light and the various components of the build volume (e.g., work surface). In some instances, heat generation in the build volume and/or any other component of the additive manufacturing system may generate light associated with spectral emission and/or black body radiation of the heated materials (e.g., at wavelengths between UV to far infrared). It should be appreciated that the beam blocks described herein may redirect stray light from any source, as the present disclosure is not limited by the source or wavelength of the stray light.

As used herein, the terms “optically active space,” “optical space,” and similar terms may refer to any space into which an intended path of the laser beam(s) (i.e., a “beam path”) may pass, or into which stray light energy diverted from the beam path may pass. This may include any space in which an optical component is disposed, any free space between two or more optical components, and/or any space in which a component or portion of a component (e.g., a surface of a component) is disposed which may be exposed to light energy emitted in conjunction with operation of the laser beam(s) (including stray light energy diverted from a beam path).

As used herein, a “pose” may be defined by a position and an orientation of an object such as a module or component. For example, adjusting a pose of a first module relative to an adjacent module may include translating the first module along a longitudinal axis, translating the first module in a transverse (e.g., radial) direction perpendicular to the longitudinal axis, and/or rotating the first module about the longitudinal and/or an axis parallel to the transverse direction. Of course translations and/or rotations in other directions or combinations of directions may also be used as the disclosure is not limited to how the pose of the various modules are manipulated during assembly and fixation of the optical modules.

In some embodiments, incident laser spots on a build surface may be arranged in a line with a long dimension and a short dimension, or in an array. In either case, according to some aspects, a line, or array, of incident laser energy consists of multiple individual laser energy pixels arranged adjacent to each other that can have their respective power levels individually controlled. Each laser energy pixel may be turned on or turned off independently and the power of each pixel can be independently controlled. The resulting pixel-based line or array may then be scanned across a build surface to form a desired pattern thereon by controlling the individual pixels during translation of the optics assembly.

Depending on the particular embodiment, an additive manufacturing system according to the current disclosure may include any suitable number of laser energy sources. For example, in some embodiments, the number of laser energy sources may be at least 5, at least 10, at least 50, at least 100, at least 500, at least 1,000, at least 1,500, or more. In some embodiments, the number of laser energy sources may be less than 2,000, less than 1,500, less than 1,000, less than 500, less than 100, less than 50, or less than 10. Additionally, combinations of the above-noted ranges may be suitable. Ranges both greater and less than those noted above are also contemplated as the disclosure is not so limited.

Additionally, in some embodiments, a power output of a laser energy source (e.g., a laser energy source of a plurality of laser energy sources) may be between about 50 W and about 2,000 W (2 kW). For example, the power output for each laser energy source may be between about 100 W and about 1.5 kW, and/or between about 500 W and about 1 kW. Moreover, a total power output of the plurality of laser energy sources may be between about 500 W (0.5 kW) and about 4,000 kW. For example, the total power output may be between about 1 kW and about 2,000 kW, and/or between about 100 kW and about 1,000 kW. Ranges both greater and less than those noted above are also contemplated as the disclosure is not so limited.

Depending on the embodiment, an array of laser energy pixels (e.g., a line array or a two dimensional array) may have a uniform power density along one or more axes of the array including, for example, along the length dimension (i.e. the longer dimension) of a line array. In other instances, an array can have a non-uniform power density along either of the axes of the array by setting different power output levels for each pixel's associated laser energy source. Moreover, individual pixels on the exterior portions of the array can be selectively turned off or on to produce an array with a shorter length and/or width. In some embodiments, the power levels of the various pixels in an array of laser energy may be independently controlled throughout an additive manufacturing process. For example, the various pixels may be selectively turned off, on, or operated at an intermediate power level to provide a desired power density within different portions of the array.

Generally, laser energy produced by a laser energy source has a power area density. In some embodiments, the power area density of the laser energy transmitted through an optical fiber is greater than or equal to 0.1 W/micrometer², greater than or equal to 0.2 W/micrometer², greater than or equal to 0.5 W/micrometer², greater than or equal to 1 W/micrometer², greater than or equal to 1.5 W/micrometer², greater than or equal to 2 W/micrometer², or greater. In some embodiments, the power area density of the laser energy transmitted through the optical fiber is less than or equal to 3 W/micrometer², less than or equal to 2 W/micrometer², less than or equal to 1.5 W/micrometer², less than or equal to 1 W/micrometer², less than or equal to 0.5 W/micrometer², less than or equal to 0.2 W/micrometer², or less. Combinations of these ranges are possible. For example, in some embodiments, the power area density of the laser energy transmitted through the optical fiber is greater than or equal to 0.1 W/micrometer² and less than or equal to 3 W/micrometer².

Depending on the application, the laser beam(s) may be scanned across a build surface of an additive manufacturing system in any appropriate fashion. For example, in one embodiment, one or more galvo scanners may be associated with one or more laser energy sources to scan the resulting one or more laser pixels across the build surface. Alternatively, in other embodiments, an optics assembly may be mounted to a gantry assembly including supporting structures such as: rails, columns, linear bearings, wheels, threaded shafts, and/or any other appropriate structure capable of supporting the various components during the desired movement. Movement of the components may also be provided using any appropriate type of actuator including, but not limited to, electric motors, stepper motors, hydraulic actuators, pneumatic actuators, electric actuators, ball screw driven stages, linear motor stages, linear actuators, belt driven linear actuators, ball screw driven linear slides, and/or any other appropriate type of actuator as the disclosure is not so limited. In any case, it should be understood that the disclosed systems and methods are not limited to any particular construction for scanning the laser energy across a build surface of the additive manufacturing system.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

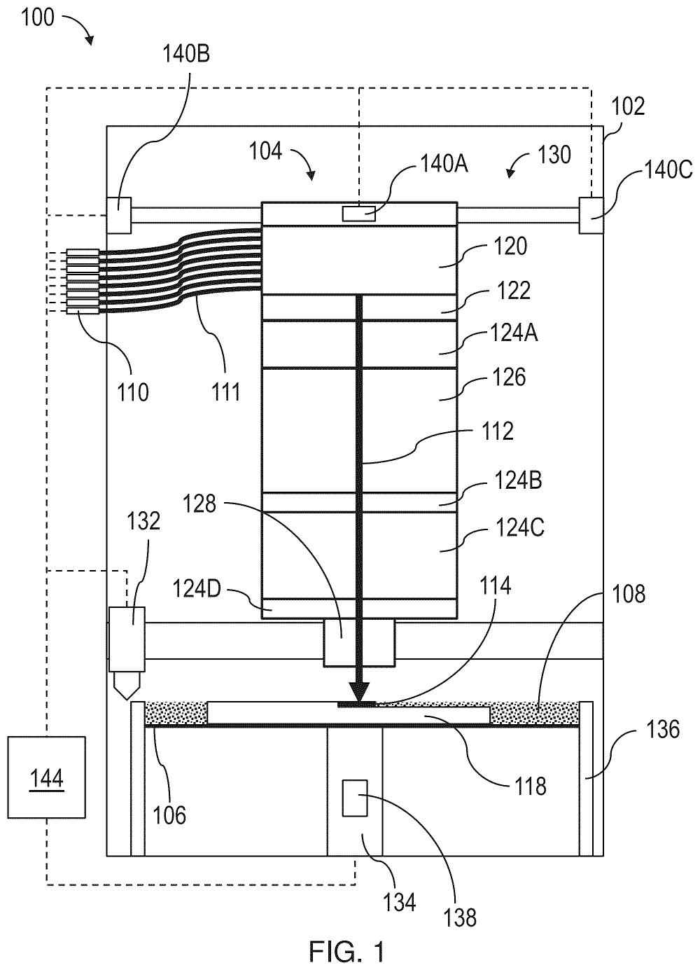

FIG. 1 shows a schematic depiction of an additive manufacturing system 100 according to some embodiments. The additive manufacturing system 100 may comprise a build chamber 102 that contains an optics assembly 104 suspended above a build plate 106 that supports a precursor material 108. The precursor material 108 may be any appropriate material for additive manufacturing, including any appropriate plastic, metal, polymer, composite, or other powdered or non-powdered material. The optics assembly may be optically coupled to one or more laser energy sources 110, for example via one or more optical fibers 111. In some embodiments, the one or more laser energy sources 110 may comprise a plurality of laser energy sources as discussed above. Similarly, in some embodiments, the one or more optical fibers 111 may comprise a plurality of optical fibers. Additionally, in some embodiments, each optical fiber 111 may be optically coupled to a respective laser energy source 110.

The optics assembly 104 may be configured to transform, shape, direct, and/or otherwise interact with laser energy 112 as the laser energy passes through the optics assembly 104 toward the build plate 106. For example, in some embodiments, an optics assembly may include one or more optical components (e.g., lenses, mirrors, apertures configured to interact with the laser energy as the laser energy passes through the optics assembly. In some embodiments, an optics assembly may include a plurality of optical components. Additionally, in some embodiments, the optics assembly may be configured to direct the laser energy 112 onto the build surface (i.e., the top surface of precursor material 108) as an array of laser energy pixels. In some embodiments, each laser energy pixel may be generated by a respective laser energy source 110, and may form a respective melt pool 114 on the build surface (although it will be understood that melt pools from multiple pixels may combine to form a single melt pool). In some embodiments, each laser energy source 110 may be optically coupled to a respective optical fiber 111 configured to direct the laser energy to the optics module. Further, in some embodiments, each laser energy source 110 may be individually controllable by one or more controllers 144, which may be operatively coupled to each laser energy source. In this regard, the one or more controllers 144 may be configured to control each laser energy source 110 individually, for example by individually adjusting a power level of each laser energy source, such that one or more processors associated with the controllers which may be associated with corresponding non-transitory computer readable memory may selectively activate or deactivate each individual laser energy pixel, and/or control a power setting for each individual laser energy pixel of the array of laser energy pixels.

As shown in FIG. 1, an optics assembly may include one or more modules that may be serially arranged and joined together to form the optics assembly. Depending on the embodiment, an optics assembly 104 may include any appropriate module configured for any appropriate function(s). For example, in some embodiments, an optics assembly 104 may include at least one optics module including one or more optical components configured to interact with the laser energy 112 as the laser energy 112 passes through the optics assembly 104. In the depicted embodiment, the optics assembly 104 may include a first optics module 124A, a second optics module 124B, a third optics module 124C, and a fourth optics module 124D. Additionally or alternatively, the optics assembly may include a cooling module 126 comprising one or more cooling components configured to manage light energy and/or heat energy within the optics assembly 104. In some embodiments, a cooling module 126 may be located in an area of the optics assembly 104 where a relatively high degree of stray light and/or heat is imparted to the optics assembly. Additionally or alternatively, in some embodiments, a cooling module 126 may be located in an area between two optical components which are spaced apart in the assembly. In this regard, the spacing of optical components may be influenced by their optical functions and the beam characteristics that are desired in a given application. Thus, in some embodiments, there may be substantial space between optical components. The inventors have recognized and appreciated the benefits of utilizing this space to manage the light and/or heat energy imparted into the optics assembly, for example by including a cooling module 126 in the space between two or more optical components.

Additionally or alternatively, an optical fiber module 120 may be included to receive the optical fiber(s) 111, and to align and/or position the end(s) of the optical fiber(s) 111 such that the laser energy 112 may be emitted therefrom in a desired configuration as discussed above. Further, in some embodiments, an interface module 122 may be included to provide a desired interface between modules (e.g., a sealing interface), and/or to provide a desired spacing between modules. Additionally or alternatively, an optics shield module 128 may include one or more components configured to inhibit particulate matter (e.g., ejecta from the melt pool 114) from entering the optics assembly 104 or an optical space thereof. For example, one or more components of an optics shield module 128 may direct a flow of gas out of the optics assembly 104.

In some embodiments, the optics assembly 104 may be moveable relative to the build plate 106 and/or build surface by a gantry system 130 configured to scan the optics assembly 104, and correspondingly the incident laser energy 112, across various portions of the build surface corresponding to a top layer of precursor material 108. The gantry system 130 may include any appropriate arrangement of support columns, rails, bearings, actuators (e.g., actuators 140A-140C), and/or other appropriate components such that the gantry 130 may be configured to translate the optics assembly 104 in any desired direction to any desired position in the build chamber 102. In some embodiments, in addition to translational movement of the optics assembly 104, this may also include rotational movements of the optics assembly 104. Alternatively, embodiments in which the optics assembly 104 includes galvomirrors or other appropriate components that are configured to scan the laser energy 112 across the build surface while the optics assembly 104 is held stationary in the build chamber 102 are also contemplated.

After being exposed to the laser energy 112, melted portions of precursor material may cool, solidify, and/or fuse together to form corresponding weld tracks on the build surface extending behind a path of travel of the laser pixels across the build surface. In various embodiments, each pixel may form a separate corresponding weld track, and/or multiple pixels may cooperate to form a combined weld track. When adjacent portions of the precursor material 108 have previously been melted, fused, and/or solidified, the melted portion may fuse with the adjacent portions to form a built part 118. This process may be conducted iteratively, with a new layer of precursor material 108 being deposited on top of the built part 118 until the built part is completed. In some embodiments, a recoater 132 may be included to deposit each layer of precursor material. In various embodiments, a recoater 132 may include or be coupled to a powder hopper or other source of precursor material, and may include a blade, an electrostatic structure, or any other appropriate arrangement to smooth a surface of the deposited powder. Additionally, in some embodiments, the system 100 may further include one or more build plate supports 134 and/or a powder containment shroud 136. The shroud 136 may extend around at least a portion of a perimeter of the build plate 106 and may extend in one or more directions perpendicular to the build plate 106. In some embodiments, the shroud 136 may extend in a vertical direction from the build plate 106 and may cooperate with the build plate 106 to define a build volume configured to receive the precursor material 108. Although the depicted embodiment includes only a single build plate support 134, other embodiments may include any appropriate number of build plate supports, as the disclosure is not limited in this regard. For example, in some embodiments, an additive manufacturing system may include two, three, four, or any other appropriate number of build plate supports 134 configured to support and/or index the build plate as described above.

In some embodiments, the build plate 106 may be secured to and/or supported by the build plate support 134. Additionally, in some embodiments, the build plate 106 and/or build plate support 134 may be operably connected to at least one build plate actuator 138. A build plate actuator 138 may be configured to translate a build plate support 134 and/or a build plate 106 of the system relative to a shroud 136 of the system. In some the embodiment shown, the build plate actuator 138 may be configured to translate the build plate 106 vertically relative to the shroud 136 to change a size of the build volume. To carry out an iterative build process as described herein, the build plate actuator 138 may index the build plate 106 downwardly after a layer of material has been fused or partially fused, such that a new layer of material may be deposited onto the fused layer (e.g., by the recoater 132). In such an embodiment, the recoater 132 may be held vertically stationary for dispensing precursor material 108, such as a precursor powder, onto the exposed build surface as the recoater 132 is moved across the build surface each time the build plate 106 is indexed downwards.

Although FIG. 1 depicts a system 100 in which the build plate 106 is indexed with respect to the shroud 136, it should be appreciated that in other embodiments, the shroud 136 may additionally or alternatively be indexed relative to the build plate 106, as the disclosure is not limited to a particular arrangement by which the build volume is iteratively expanded to enable the build processes described herein. For example, a shroud 136 may be operatively coupled with a shroud actuator (not shown) configured to translate the shroud 136 in a vertical direction relative to the build plate. In some such embodiments, the additive manufacturing system may also include an optics assembly 104 that is supported on a vertical motion stage that is in turn mounted on the gantry 130 to index the optics assembly 104 (e.g., to maintain a desired spacing between the optics assembly 104 and the build surface as the build volume is expanded vertically by actuation of the shroud 136).

In some embodiments, one or more controllers 144 may be operatively coupled to the various actively controlled components of the additive manufacturing system 100. For example, the one or more controllers may be operatively coupled to the laser energy sources 110, the actuators 140A-140C, the recoater 132, the build plate actuator 138 and/or any other appropriate component of the system. In some embodiments, the controller(s) 144 may include one or more processors and associated non-transitory computer readable memory. The non-transitory computer readable memory may include processor executable instructions that, when executed by the one or more processors, cause the additive manufacturing system 100 to perform any of the additive manufacturing methods disclosed herein.

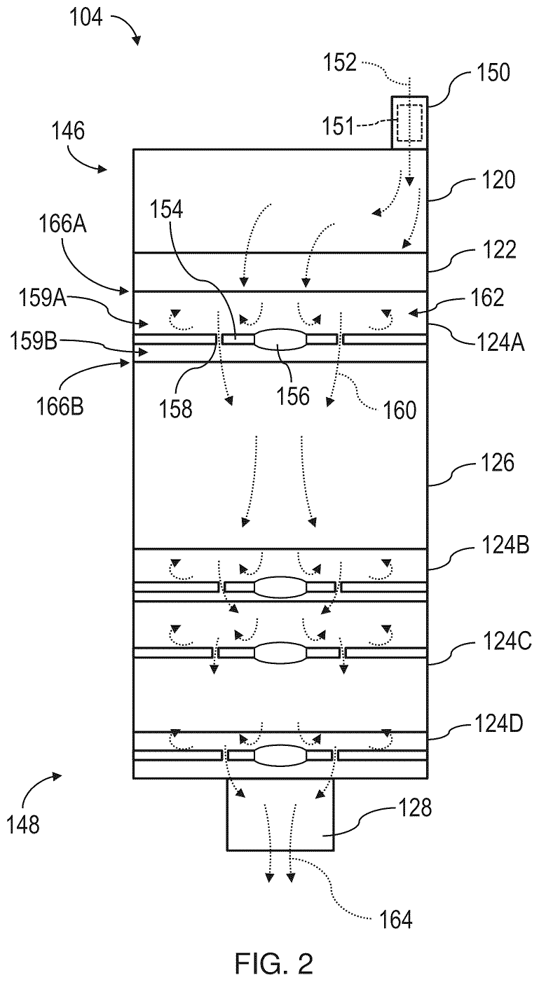

As noted previously, it may be desirable to provide an optics assembly 104 that is pressurized relative to a surrounding environment (e.g., the build chamber 102) and that is configured to direct a flow of gas therethrough to help prevent the ingress of and/or remove contaminants such as gas and particles from within the optics assembly. As shown in FIG. 2, an optics assembly 104 may include a plurality of serially arranged and connected modules that may be configured to permit a flow of gas to pass through at least a portion of each module. As shown in the figure, an optics assembly 104 may include a proximal end portion 146 and a distal end portion 148. In some embodiments, the optics assembly 104 may be configured to direct laser energy from the proximal end portion 146 to the distal end portion 148 toward a build plate disposed distally from the distal end portion 148. Additionally, in some embodiments, the flow of gas may enter the optics assembly 104 at the proximal end portion 146 and exit the optics assembly at the distal end portion 148. For example, in the embodiment shown, the proximal end portion 146 may include a gas flow inlet 150 fluidly coupled to a gas flow source (not shown) to receive a flow of inlet gas 152 from the gas flow source, and the distal end portion 148 may include an optics shield module 128 having a gas flow outlet configured to direct a flow of outlet gas 164 out of the optics assembly 104.

In some embodiments, the gas flow inlet 150 may include one or more gas filters 151 (e.g., a HEPA filter, an ULPA filter, or others) configured to inhibit entry of particulate matter into the optics assembly 104 and/or optical space. In some embodiments, the one or more gas filters 151 may include any appropriate number of sequentially arranged filters, including one filter or a plurality of filters. The inlet gas 152 may flow from the gas flow inlet 150 through the filter(s) 151 and into an interior portion of the optics assembly 104, and may flow sequentially through an interior portion of each sequentially located module. In the embodiment shown, the gas may flow from the gas flow inlet 150, through an optical fiber module 120, through an interface module 122, and into a first optics module 124A. In some embodiments, two or more modules may be joined together using an intermodular seal as discussed herein, which may be gas tight to inhibit gas and/or particulate matter from passing into and/or out of the optics assembly 104 other than through the gas flow inlet 150 or gas flow outlet (e.g., a gas flow outlet of the optics shield module 128). In the embodiment shown, the first optics module 124A may be joined to the interface module 122 using a first intermodular seal 166A, and may further be joined to a cooling module 126 using a second intermodular seal 166B. For ease of illustration, only the first and second intermodular seals 166A, 166B have been labeled in the figure, but it will be understood that each module of the optics assembly 104 may additionally be joined to one or more adjacent modules using a similar arrangement of intermodular seals.

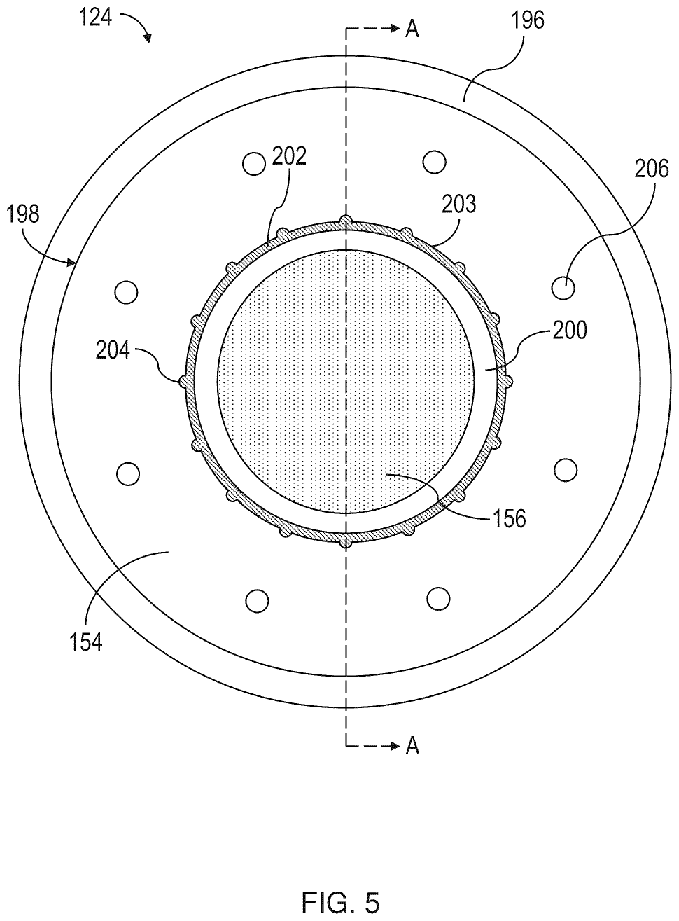

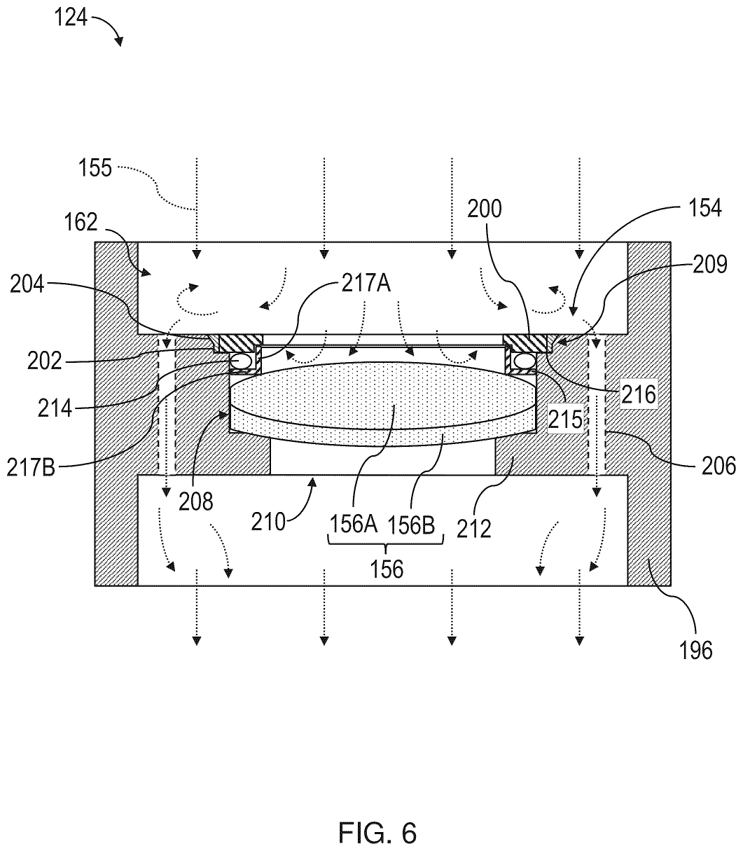

As described in further detail below, each optics module 124A-124D may include one or more optical components 156 mounted within an interior space (e.g., an optical space) of the optics module 104. Accordingly, each optics module 124A-124D may include an optics mount 154 configured to retain one or more optical components 156 within a housing of the optics module. As will be described in further detail with reference to FIGS. 5-6, an optics mount 154 may include a solid portion to which the optical component(s) 156 may be mounted, and which may surround the optical component(s) 156. The optics mount 154 may cooperate with the optical component(s) 156 to divide the optical space within the optics module into in a first volume 159A located proximally to and/or upstream from the optical component(s) 156, and a second volume 159B located distally to and/or downstream from the optical component(s) 156. The first and second volumes 159A, 159B may be in fluid communication across the optics mount 154 via one or more bypass channels 158 formed in the solid mounting portion of the optics mount 154, the bypass channel(s) 158 configured to allow a flow of gas to bypass the optical component(s) 154 retained in the optics mount 154. Each bypass channel 158 may extend through the optics mount, and may be configured to permit a respective bypass flow 160 to pass through the optics mount and/or around the optical component(s) 156 (e.g., from a proximal/upstream side to a distal/downstream side of the optical component(s)). Further, in some embodiments, the bypass channel(s) 158 may individually or collectively be configured to restrict a flow from a first side of an optical component to a second side (e.g., from the proximal/upstream side to the distal/downstream side), which may induce recirculation of the gas flow on the first (i.e., upstream) side of each optics module. Thus, in some embodiments, an optics mount 156 may be configured to cause recirculation in the flow of gas through the optics assembly 104, for example to provide convective cooling to the one or more optical components 156. Accordingly, in some embodiments, an optics module 124 may include a recirculation region 162 in which the flow of gas may be recirculated. In some embodiments and as shown, a recirculation region 162 of an optics module may be disposed on a proximal side of an optics mount 154 and/or optical component 156 of the optics module. In the embodiment shown, the recirculation region 162 may be formed in the first volume 159A upstream from the optical component(s) 156.

As will be appreciated, some such recirculating arrangements may be associated with greater pressure on an upstream side of the optics mount 154/optical component 156 relative to the downstream side. As an optics mount 154 and/or optical component 156 may become dislodged and/or damaged if the pressure thereon exceeds a threshold pressure, the bypass channel(s) 158 may further be configured to maintain a pressure differential across an optics mount 154 and/or optical component 156 below a desired threshold pressure differential. For example, the bypass channel(s) 158 may be sized and shaped to allow sufficient flow therethrough to prevent a pressure differential between an upstream side (i.e., a proximal side or first volume 159A) and downstream side (i.e., a distal side or second volume 159B) of the optical component 156. Thus, the bypass channel(s) 158 may be sized and shaped to permit overall flow through the optics module while permitting flow recirculation and avoiding excess pressure on an optical component 156.

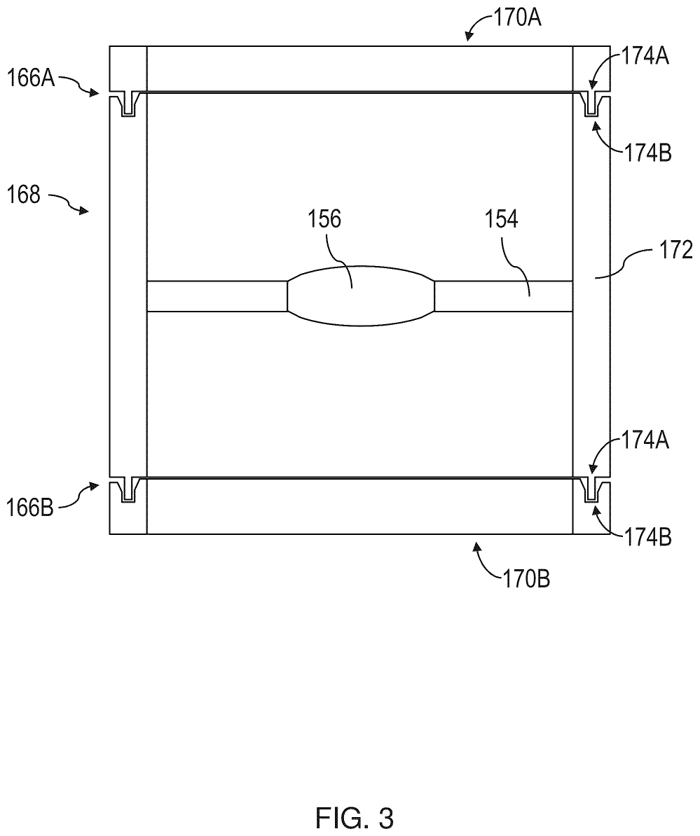

As noted above, a first module of an optics assembly may be joined to one or more adjacent serially arranged modules of the optics assembly using one or more intermodular seals. For example, as shown in FIG. 3, a first module 168 may comprise an optics module as disclosed herein, and may be joined to a first adjacent module 170A by a first intermodular seal 166A. The first module 168 may further be joined to a second adjacent module 170A by a second intermodular seal 166B. It will be appreciated that the first module 168 and each of the first and second adjacent modules 170A, 170B may be any type of module used in an optics assembly, including an optics module, an interface module, a cooling module, an optics shield module, a fiber optic module, and/or any other appropriate type of module, as intermodular seals are not limited to use with only particular types of modules or only particular combinations of modules. Rather, an optics assembly having a plurality of serially arranged and connected modules may include an intermodular seal between each pair of adjacent modules to provide an overall sealed volume within the overall optics assembly, with the above-noted optional bypass flow channels permitting flow through the overall sealed volume. Thus, the depiction in FIG. 3 of the first module 168 as an optics module is provided as an illustrative example only and does not limit intermodular seals to applications or embodiments that include an optics module.

As shown in FIG. 3, the first module 168 may include a module housing 172 having a generally tubular construction (i.e., a hollow structure configured to extend along a portion of an axial length of the optics assembly when installed in the optics assembly). The module housing 172 may be formed with any appropriate transverse cross-sectional shape. In the embodiment shown, the module housing 172 may have a round or circular transverse cross-sectional shape, however other shapes are also contemplated including any regular or irregular polygon having any appropriate number of sides (e.g., a square or rectangle, a hexagon, an octagon, etc.). In some embodiments, the module housing 172 may be configured to receive and/or retain various components of the module (e.g., an optical component 156, an optics mount 154, an energy management component such as a beam block or heat sink, a gas flow component such as a gas flow passage, and/or others). The module housing 172 may include a first module fitting 174A and a second module fitting 174B disposed at opposing end portions. In some embodiments, a first module fitting 174A of the first module 168 may be configured to engage with a second module fitting 174B of a first adjacent module 170A, and a second module fitting 174B of the first module 168 may be configured to engage with a first module fitting 174A of a second adjacent module 170B. In some embodiments, a module may include only a first module fitting 174A or a second module fitting 174B, as some modules may be configured to join with only a single adjacent module. For example, a module configured to be positioned at a distal or proximal end of an optics assembly may have only a single module fitting at a single end portion thereof, as the opposing end portion may not engage with another module.

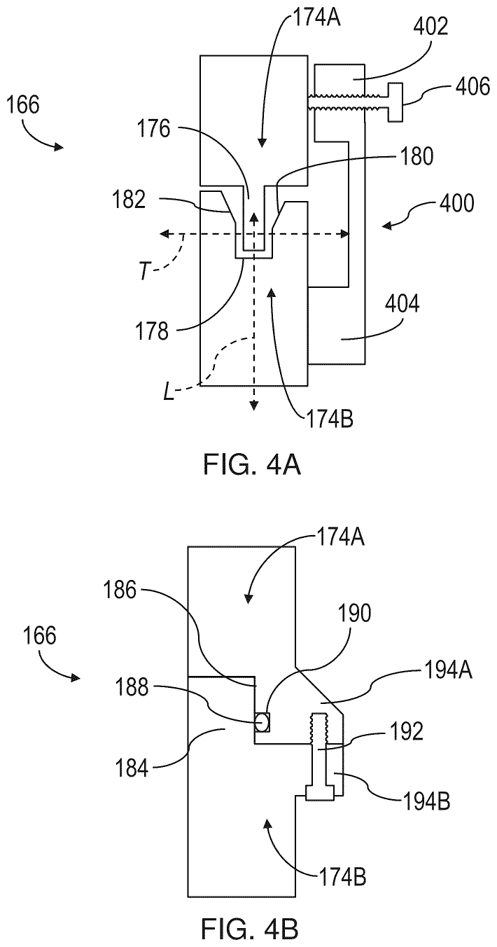

FIGS. 4A and 4B depict two exemplary embodiments of an intermodular seal 166 by which two modules of an optics assembly may be connected. As shown of FIG. 4A, an intermodular seal 166 may be cooperatively formed by a first module fitting 174A of a first module and a second module fitting 174B of an adjacent second module. In some embodiments, a first module fitting 174A may include a portion configured to be inserted into a corresponding portion of the second module fitting 174B. For example, the first module fitting 174A may include a tongue 176 configured to be inserted into a portion of the second module fitting 174B. In some embodiments, the tongue 176 may extend from an end portion of the first module housing 172, for example in a longitudinal direction. Additionally, a second module fitting 174B may include a portion configured to receive a corresponding portion of a first module fitting 174A. For example, the second module fitting 174B may include a groove 178 formed on an end portion of the module housing 172 that is configured to receive a portion of the first module fitting 174A. In the embodiment shown, the first module fitting 174A may include a tongue 176 configured to be inserted into a groove 178 of the second module fitting 174B. As will be appreciated with reference to the cross-sectional view of FIG. 3, each of the tongue 176 and the groove 178 may extend around a peripheral area or perimeter of their respective module housings, such that the tongue 176 and the groove 178 may surround an interior portion of their respective modules.

In some embodiments, a first and second module fitting may be joined by an adhesive material (e.g., an epoxy, sealant, resin, bonding agent, glue, or other adhesive). For example, an adhesive material may be deposited into the groove 178 of a second module fitting 174B to retain a tongue 176 of a first module fitting 174A in the groove 178. Accordingly, there may be sufficient clearance between the tongue 176 and the groove 178 to provide space in which the adhesive material may flow (e.g., by injection or other application process) or otherwise be disposed and to permit reorientation of the sequentially located module housings 172 relative to each other such that the module housings 172 (and the components contained therein) may be properly aligned with one another as elaborated on further below.

As noted above, such tongue-in-groove arrangements as shown in FIG. 4A may facilitate proper alignment of the two modules during assembly. In some embodiments, the tongue 176 may be inserted into the groove 178, and an adhesive material may be deposited into the groove 178 to retain the tongue 176 therein. As the adhesive material may require time to cure, set, or otherwise solidify, the tongue 176 may be movable within the groove 178 until the adhesive material has solidified. For example, the tongue 176 may be movable in a longitudinal direction L and/or a transverse direction T within the groove 178. The tongue 176 may further be rotatable within the groove 178, for example about a central axis of the first module or the optics assembly.

In various embodiments, the first and second module fittings 174A, 174B may be aligned using any appropriate arrangement or technique. In some embodiments, one or more fixtures may be used to control and/or adjust the alignment to achieve a desired alignment. For example, a fixture 400 may include a first fixture portion 402 adjustably attached to the first module or the first module fitting 174A thereof, and a second fixture portion 404 fixedly attached to the second module or the second module fitting 174B thereof. The first fixture portion 402 may be configured to permit a pose of the first module to be adjusted relative to the second module, and the second fixture portion 404 may be configured to maintain a pose of the second module relative to the first module. For example, the second fixture portion 404 may clamp or otherwise secure the second module in place to maintain the second module fitting 174B in a desired pose, while the first fixture portion 402 may include one or more set screws 406 configured to cooperatively control a positioning of the first module fitting 174A. The set screws 406 may be disposed at intervals around a perimeter of the first module housing, such that the set screws 406 may be operated to control a positioning of the first module fitting 174A in at least the transverse direction T. For example, where a first and second set screw 406 are disposed on opposing sides of the first module, tightening the first set screw 406 and loosening the second may translate the first module and first module fitting 174A in the transverse direction toward the second set screw. Additionally, loosening some or all set screws 406 may allow the first module and first module fitting 174A to be translated in the longitudinal direction L, and/or rotated about a longitudinal axis of the first module. Although these processes have been exemplified using set screws and illustrated schematically as shown in FIG. 4A, it will be appreciated that other arrangements for adjusting the relative poses of modules are also contemplated as the present disclosure is not limited to the use of set screws in this regard. For example, other embodiments may additionally or alternatively utilize multi-axis tooling (e.g., using adjustable/movable clamps or grippers), shims, or any other appropriate arrangement to facilitate translation and/or rotation of one module relative to another. Further, in some embodiments, an alignment of the first and second module may be set and/or adjusted during a cure time of the adhesive material, as the adhesive material may exhibit an appropriate amount of plasticity or compliance to permit the module fittings to be moved while it is curing, and may exhibit an appropriate bond strength to maintain the desired alignment after it has cured.

In some embodiments (for example, where one or both of the first and second modules is an optics module or is connected to an optics module), the alignment of the first and second module may be set to achieve a desired alignment of two or more optical components disposed in two or more optics modules. In some embodiments, this may be achieved using a rotational laser calibration process, in which a laser beam is directed through the two or more optical components and onto a calibration surface. The optics assembly (or partial optics assembly) may then be rotated about a central axis, such that the laser beam travels in a circular beam path on the calibration surface. The size (i.e., diameter), eccentricity, and/or other characteristic(s) of the circular beam path may be monitored, and the alignment of the optics modules may be adjusted in order to achieve a desired size, eccentricity, or other characteristic. In some embodiments, such a rotational calibration process may be performed during the cure time of an adhesive material (e.g., an adhesive material retaining a tongue 176 within a groove 178). Further, in some embodiments, an optics assembly 104 having a plurality of serially arranged and connected modules may be manufactured by repeating the processes described herein for each module (or at least for each optics module) when the module is connected to the assembly. In some embodiments, the first and second fixture portions 402, 404 may be configured to facilitate synchronous rotation of the first and second modules. For example, in the embodiment shown, the set screws 406 may be tightened against the first module such that rotation of the fixture 400 results in synchronous rotation of both modules. The set screws 406 may be operated between periods of rotation to permit the first module fitting 174A to be adjusted as described above.

In some embodiments, a module fitting may include one or more features configured to facilitate application of the adhesive material. For example, a groove 178 may be configured to facilitate deposition of an adhesive therein. In some embodiments, a groove 178 may include a chamfer, fillet, curvature, taper, or other surface geometry to facilitate deposition, injection, and/or flow of the adhesive into the groove. For example, the groove 178 may include a chamfer 180 on an external wall of the groove to facilitate deposition of epoxy or adhesive into the groove 178 while the tongue 176 is disposed within the groove 178. Additionally or alternatively, an external wall of the groove 178 may be lower than an internal wall on an opposing side of the groove 178, such that a gap may be left between the external wall and the adjacent module housing. In some embodiments, adhesive may be applied into and/or through the gap, and may flow into the groove 178. Further, an internal wall of the groove 178 may include a chamfer 182 to form a space into which adhesive may flow (e.g., to provide a desired bond strength, and/or to prevent overflow of excess adhesive).

In some embodiments, a tongue-in-groove arrangement such as the arrangement of FIG. 4A may provide a gas tight intermodular seal while inhibiting particulate matter from entering the optical space, as some such arrangements may not require any threaded fasteners, and the clearance provided for the deposition of adhesive material may prevent contact between the first and second module housings. Furthermore, the adhesive material may be a low off-gassing adhesive material, such as DGEBA, DGEBF, or others.

FIG. 4B depicts an alternative arrangement for forming an intermodular seal 166 to connect two modules of an optics assembly 104. In some embodiments, a portion of a first module fitting 174A may be configured to receive a portion of a second module fitting 174B, and the portion of the second module fitting 174B may be configured to be inserted into the portion of the first module fitting 174A. For example, a collar 184 of the second module fitting 174B may be configured to be inserted into a receptacle 186 of the first module fitting 174A. The collar 184 may be retained in the receptacle 186 in any appropriate way, including the use of adhesive materials and the associated clearances described above. For example, although not depicted, a clearance sufficient to receive adhesive material may be provided between the collar 184 and the receptacle 186. Alternatively, as shown in FIG. 4B, the collar 184 may be retained in the receptacle 186 using a seal 188. In various embodiments, the seal 188 may comprise an O-ring, a gasket, or other resilient component(s) extending around an internal perimeter or circumference of the receptacle 186. In some embodiments, the seal 188 may be in compressive contact between the collar 184 and the receptacle 186, and may form a gas tight seal therebetween. The gas tight seal may be configured to prevent gas and/or particulate matter from passing between the collar 184 and the receptacle 186. In some embodiments, the seal 188 may be disposed in a channel 190 of the intermodular seal 166. In this regard, at least one of the collar and the receptacle may include a channel 190 sized and shaped to receive a seal 188. In various embodiments, the channel 190 may be formed in an exterior surface of the collar 184 and/or an interior surface of the receptacle 186.

In some embodiments, an intermodular seal 166 may optionally include one or more fasteners 192 to retain the first and second module fittings 174A, 174B together. In some embodiments, the one or more fasteners 192 may be threaded. Further, in some embodiments which include a threaded fastener 192, the threaded fastener 192 may be disposed on an external portion of the optics assembly 104. In some embodiments, to combat the particulate-related issues discussed herein, a threaded fastener 192 may be disposed outside of an optical space, or in an area external to an intermodular seal 166 configured to prevent particulate matter generated from tightening of the threaded fastener(s) 192 from entering the optical space. In some embodiments, all threaded fasteners of an optics assembly 104 may be disposed outside of the optical space, and/or in an area external to one or more seals configured to prevent particulate matter from entering the optical space (e.g., gas tight intermodular seals as described herein). As shown in FIG. 4B, the one or more threaded fasteners 192 may be disposed in an area external to the seal 188, which may be configured to prevent particulate matter from entering an optical space on an interior side of the intermodular seal 166. In some embodiments and as shown, the first module fitting 174A may include a first flange 194A and the second module fitting 174B may include a second flange 194B. The threaded fastener(s) 192 may extend through at least one of the first flange 194A and the second flange 194B to secure the first and second flanges together. The arrangement of FIG. 4B may provide a gas tight intermodular seal 166 while preventing particulate matter from entering the optical space, as the seal 188 may prevent particulate matter generated by the threaded fastener 192 from entering the optical space.

As shown in FIG. 5, an optics module 124 of an optics assembly 104 may include an optics module housing 196. An optics module housing 196 may at least partially define an optical space 198 within the optics module 124. Additionally, the optics module housing 196 may include or be attached to an optics mount 156 configured to retain one or more optical components 156 within the optics module housing 196. In some embodiments, the optics mount 154 may be configured to retain the optical component 156 at a desired position and/or orientation within the optical space 198. For example, as described in greater detail with reference to FIG. 6, an optics mount 154 may include a retaining plate 200 configured to retain the optical component 156 within the optics mount 154. In various embodiments, the retaining plate 200 may be held within the optics mount 154 using any appropriate arrangement, including fasteners, threaded fittings, press fit, snap fits, and/or any other appropriate arrangement. In the depicted embodiment, to avoid the generation of particles, the retaining plate 200 may be held in place using an adhesive material 202, which may be deposited around at least a portion of a perimeter of the retaining plate 200. In some embodiments, the adhesive material 202 may be a low off-gassing adhesive material, such as DGEBA, DGEBF, or others. As will be appreciated with reference to FIG. 6, the retaining plate 200 may be disposed within a retaining recess 209 of the optics mount 154. An outer transverse dimension of the retaining plate 200 may be less than an inner transverse dimension of the retaining recess 209, such that a gap or channel 203 may be formed between an outer surface of the retaining plate 200 and an inner surface of the retaining recess 209. In some embodiments, the adhesive material 202 may be deposited (e.g., injected) in the channel 203 to secure the retaining plate 200 within the retaining recess 209. Further, in some embodiments, the inner surface of the retaining recess 209 may be formed with one or more wells 204 to facilitate deposition of the adhesive material 202 within the channel 203, and/or to provide a space into which excess adhesive may flow to prevent overflow.

As shown in FIGS. 5-6, an optics mount 154 may additionally include one or more bypass channels 206 configured to allow a flow of gas through the optics mount 154 and/or around the optical component 156. In some embodiments, the bypass channel(s) 206 may be formed in a portion of the optics mount 154 spaced outwardly from the optical component 156 along a transverse dimension. For example, in some embodiments, the bypass channels 206 may be disposed radially outwardly from the optical component 156. Further, as shown in FIG. 5, the bypass channels 206 may be disposed at regularly-spaced intervals around a perimeter of the optical component 156, although the bypass channels 206 may alternatively have any desired spacing, including an irregular spacing.

FIG. 6 depicts a cross-sectional view of an optics assembly 124, for example as taken along line A-A of FIG. 5. As shown in the cross-sectional view, an optics mount 154 may be formed within or as part of an optics module housing 196. In some embodiments, an optics mount 154 may extend from an interior surface of the optics module housing 196 into an interior space of the optics module 124, and may include an aperture 210 extending axially through the optics mount 154. The aperture 210 may be configured to permit laser energy to pass through the optical component 156 and the optics mount 154, and may be formed as an opening on a distal side or surface of the optics mount 154. In some embodiments, an optics mount 154 may further include an optics recess 208 sized and shaped to receive an optical component 156. The optics recess 208 may be formed as an opening in the optics mount 154, and may be concentric with the aperture 210. In some embodiments, a transverse dimension (e.g., diameter, width, or other transverse dimension) of the optics recess 208 may be greater than a transverse dimension of the aperture 210, such that the optics recess 208 and the aperture 210 may cooperatively define an optics shoulder 212. In some embodiments, the optical component 156 may be disposed on the optics shoulder 212 and within the optics recess 208. In the embodiment shown, the optical component 156 is exemplified as a doublet lens comprising a first optical element 156A and a second optical element 156B, though it will be appreciated that the optical component 156 may be any appropriate optical element or combination of optical elements.

In some embodiments, the optics mount 154 may further include a retaining recess 209 sized and shaped to receive a retaining plate 200 as described above. The retaining recess 209 may be formed as an opening in a proximal side or surface of the optics mount 154, and may be concentric with the aperture 210 and/or the optics recess 208. In some embodiments, a transverse dimension (e.g., diameter, width, or other transverse dimension) of the retaining recess 209 may be greater than a transverse dimension of the optics recess 208, such that the retaining recess 209 and the optics recess 208 may cooperatively define a retaining shoulder 216. In some embodiments, the retaining plate 200 may be disposed on the retaining shoulder 216 and within the retaining recess 209. Further, in some embodiments and as described above, the retaining recess 209 may be sized and shaped to form a channel 203 between the retaining plate 200 and an internal surface of the retaining recess 209 when the retaining plate 200 is disposed in the retaining recess, and the channel 203 may include one or more wells 204. For example, a transverse dimension of the retaining recess 209 may be greater than a transverse dimension of the retaining plate, such that the channel 203 may be formed around a perimeter of the retaining plate 200 when the retaining plate 200 is disposed in the retaining recess 209 and against the retaining shoulder 216.

In some embodiments, the optics mount 154 may include a reference feature against which an optical component 156 may be located. In some embodiments, the optical component 156 may be pressed against the reference feature to ensure a proper position and/or orientation of the optical component 156 within the optics mount 154. For example, in some embodiments, a reference feature may comprise the optics shoulder 212, and the optical component 156 may be pressed against the optics shoulder 212. In some embodiments, the optics shoulder 212 may extend inwardly from the optics mount 154 to provide a surface against which the optical component 156 may be disposed and/or pressed to retain the optical component 156 in the optics mount 154. In various embodiments, the optical component 156 may be pressed against the reference feature (i.e., the optics shoulder 212) using any appropriate arrangement. For example, in the embodiment shown, the optical component 156 may be pressed against the optics shoulder 212 by compression of a resilient member 214 against the optical component 156. In some embodiments, the resilient member 214 may extend around a perimeter or a peripheral region of the optical component 156. Further, the resilient member 214 may be held in compression by the retaining plate 200 such that the resilient member 214 is compressed between the retaining plate 200 and the optical component 156 which is correspondingly pressed against the optics shoulder 212. As noted above with reference to FIG. 5, the retaining plate may be secured within the optics mount 154 by any appropriate arrangement, including an adhesive material 202 disposed in the channel 203 such as by injection into the wells 204 which are in fluid communication with the channel 203.

As noted above, in some applications, resilient materials used in a resilient member 214 may be degraded by exposure to light and/or heat. Accordingly, an optics mount 154 may further include a reflective shield 215 to reflect stray light traveling through the optics module 124 in the proximal, distal, and/or transverse direction(s) away from the resilient member 214. As shown in FIG. 6, a reflective shield 215 may be disposed at least partially between the resilient member 214 and the optical component 156. Further, in some embodiments, the reflective shield 215 may cooperate with one or more other components of the optics mount 154 to surround and/or enclose the resilient member 214. For example, the reflective shield 215 may cooperate with the retaining plate 200, an interior surface of the optics recess 208, and/or the retaining shoulder 216 to enclose the resilient member 214 and/or to inhibit interaction of stray light with the resilient member 214. In some embodiments, the reflective shield 215 may include a first leg 217A and a second leg 217B extending at an angle (e.g., a right angle, or an acute angle) from the first leg 217A. The first leg 217A may be disposed between the resilient member 214 and a beam path along with the laser beam(s) may be configured to pass through the optics assembly 104, and may be in contact with the retaining plate 200. The second leg 217B may be disposed between the resilient member 214 and the optical component(s) 156, and may be in contact with an interior surface of the optics recess 208. Thus, the first and second legs 217A, 217B may be configured to cooperate with the retaining plate 200 and the optics recess 208 to enclose the resilient member 214 to shield the resilient member 214 such that stray light incident on the reflective shield 215 is reflected away from the resilient member 214.

In some embodiments, an optics mount 154 may further include one or more bypass channels 206, as described above. As shown in FIG. 6, one or more bypass channels 206 may be formed in the optics mount 154 to allow a flow of gas 155 to pass through the optics mount 154 and/or past the optical component 156. In various embodiments, the diameter, number, spacing, and/or shape of the bypass channel(s) may be selected to cause the flow of gas 155 to recirculate (e.g., in the recirculation area 162), and/or to regulate a pressure differential across the optical component 156 and/or optics mount 154.

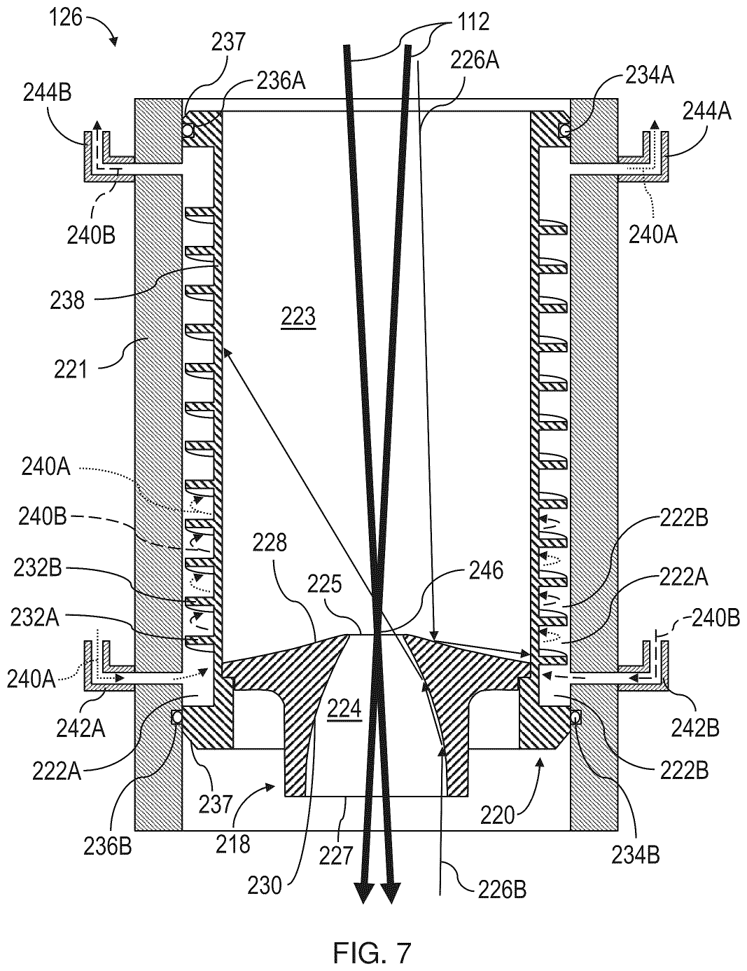

FIG. 7 depicts a cross-sectional view of a cooling module 126 for use in an optics assembly 104, according to some embodiments. As noted previously, the cooling module 126 may be included as one of the modules of a plurality of serially arranged and connected modules forming an optics assembly 104. In some embodiments, a cooling module 126 of an optics assembly 104 may be configured to receive stray light energy from one or more laser beams passing through the optics assembly 104 and/or to transfer stray light energy out of the optics assembly 104 as heat energy. In various embodiments, a cooling module 126 may include one or more energy management components such as a beam block 218, a heat sink 220, and/or one or more cooling channels 222A, 222B.

In some embodiments, a beam block 218 may be disposed along the beam path, and may include an aperture 224 sized and shaped to allow the incident light energy 112 to pass through the beam block 218 in a first direction as shown (i.e., from a proximal side of the beam block towards a distal side of the beam block and/or toward a build surface located distally from the optics assembly). In some embodiments, the aperture 224 may further be configured to allow a flow of gas to pass through the beam block 218. The beam block 218 may further include one or more surfaces configured to absorb or deflect, away from the beam path, stray light energy 226A traveling from the proximal side and/or stray light energy 226B traveling from the distal side. For example, in some embodiments, a beam block 218 may include a first surface 228 configured to deflect stray light energy 226A traveling from the proximal side of the beam block towards an interior side wall of the cooling module 126, and a second surface 230 configured to deflect stray light energy 226B traveling from the distal side of the beam block towards the interior side wall of the cooling module 126. In some embodiments, the first surface 228 may be at least partially on the proximal side of the beam block 218, and the second surface 230 may be at least partially on the distal side of the beam block 218. Further, in some embodiments, the second surface 230 may be an interior surface within the aperture 224 of the beam block 218.

In some embodiments, both the first surface 228 and the second surface 230 may be configured to deflect stray light energy towards an interior surface 223 of the cooling module 126 on the same side of the beam block (e.g., the proximal side or the distal side of the beam block). In some embodiments, the side of the beam block 218 to which the first and/or second surface 228, 230 is configured to deflect stray light may include a heat sink 220 that forms the interior surface 223 of the cooling module 126 that the redirected stray light is incident on. The exposed surface(s) of the heat sink 220 that the stray light is incident on (i.e., the interior surface 223) may be configured to absorb the stray light energy 226A, 226B. In some such embodiments, both the first surface 228 and the second surface 230 may be configured to deflect stray light energy 226A, 226B towards a single heat sink 220 on the same side of the beam block 218. For example, in the embodiment shown, the first surface 228 of the beam block 218 may be formed in a curvature configured to reflect the stray light energy 226A without permitting the stray light energy 226A to pass from the proximal side of the beam block 218 to the distal side. For example, the first surface 228 may be formed on the proximal side of the beam block 218, and may be concave along at least a portion thereof. In some embodiments, the first surface 228 further be tapered, such that the beam block 218 may taper from a narrower transverse cross-sectional area in a proximal portion (e.g., surrounding a proximal opening 225 of the aperture 224) to a wider transverse cross-sectional area in a distal portion. Thus, in some embodiments, the beam block 218 may be formed in a conical or concave conical geometry, such that the stray light energy 226A may be deflected one or more times off of the first surface 228 and towards the heat sink 220 or interior surface 223 thereof as it passes in the distal direction. Additionally or alternatively, the second surface 230 may be formed in a curvature configured to deflect the stray light energy 226B one or more times while permitting the stray light energy 226B to continue traveling at least partially towards the proximal end of the optics assembly 104. For example, the second surface 230 may be formed on an interior of the aperture 224, and may be concave along at least a portion thereof. In some embodiments, the second surface 230 may further be tapered, such that the aperture 224 may taper from a narrower transverse cross-sectional area in a proximal portion (e.g., a proximal opening 225 of the aperture 224) to a wider transverse cross-sectional area in a distal portion (e.g., a distal opening 227 of the aperture 224). Thus, in some embodiments, the second surface 230 may form the aperture 224 as a conical or convex conical space within the beam block 218, such that the stray light energy 226B may be deflected one or more times off of the second surface 230 as it passes through the aperture 224 from the distal opening 227 through the proximal opening 225 and towards the heat sink 220 or the interior surface 223 thereof. Thus, the first and second surfaces 228, 230 may cooperatively be configured such that both the stray light energy 226A traveling from the proximal side and the stray light energy 226B traveling from the distal side may be absorbed by a heat sink 218 disposed on the proximal side.

In some embodiments, the aperture 224 of the beam block 218 may be disposed at a desired location along a beam path, for example to deflect a desired amount or proportion of stray light energy. In the embodiment shown, the aperture 224 may be disposed at a telecentric cross-over point 246 (i.e., a point at which the primary rays of the laser beam(s) intersect) of the laser energy 112. In some embodiments, this may allow a minimum dimension of the aperture 224 or the proximal opening 225 (e.g., a minimum diameter, minimum length, minimum width, or other minimum transverse dimension) to be reduced to facilitate deflection of a greater proportion of stray light energy.

Further to the above, it may be desirable to facilitate the removal of heat from the heat sink 220. Thus, some cooling modules 126 may include one or more cooling channels 222A, 222B configured to direct the flow of a cooling fluid to remove heat from the heat sink 220. In some embodiments, the cooling fluid may comprise any appropriate liquid or gaseous coolant or refrigerant, although in some embodiments the cooling fluid may comprise air or water. In some embodiments, a cooling channel 222A/222B may at least partially surround a beam path or an optical space within an optics assembly 104, for example by extending around a perimeter or periphery of a heat sink 220. Additionally, in some embodiments, a cooling channel 222A/222B may be cooperatively formed between a heat sink 220 and a cooling module housing 221, such that a cooling flow 240A/240B may pass between the heat sink 220 and the housing 221. For example, in the embodiment shown, each of the first cooling channel 222A and the second cooling channel 222B may be cooperatively formed between an exterior surface or feature of the heat sink 220 and an interior surface of the cooling module housing 221. In some embodiments, one or more fins 232A, 232B may extend outwardly from an exterior wall 238 of a heat sink 220, and may at least partially define one or more cooling channels 222A, 222B. For example, in the embodiment shown, a first fin 232A and a second fin 232B may extend radially outwardly from the exterior wall 238 of the heat sink 220, and may at least partially define the first cooling channel 222A and the second cooling channel 222B.

As noted above, in some embodiments, one or more cooling channels 222A, 222B may extend around a perimeter of a heat sink. For example, in embodiments in which a heat sink 220 and/or cooling module 126 has a round or circular transverse cross-section, a cooling channel 222A/222B may extend around a circumference of the heat sink 220. In some embodiments, a cooling channel 222A/222B may additionally extend at least partially along a longitudinal direction of the optics assembly 104 or cooling module 126 to form a spiral channel around the heat sink. For example, in the embodiment shown, the first cooling channel 222A and the second cooling channel 222B may extend in a circumferential spiral arrangement around an exterior wall 238 of the heat sink 218. In some embodiments, a cooling channel 222A/222B arranged in a spiral around an exterior wall 238 of a heat sink 220 may be concentric with the heat sink 220, such that a central axis of the spiral coincides with or is parallel to a longitudinal axis of the heat sink.

Further, in some embodiments, a first cooling channel 222A and a second cooling channel 222B may be configured to permit or direct flow of a first cooling flow 232A and a second cooling flow 232B, respectively. For example, in the embodiment shown, the first cooling channel 222A may be configured to receive a first cooling flow 240A from a cooling fluid source via a first cooling flow inlet 242A, while the second cooling channel 222B may be configured to receive a second cooling flow 240B from a cooling fluid source (which may be the same cooling fluid source or a different cooling fluid source) via a second cooling flow inlet 242B. In various embodiments, a cooling fluid source may be any appropriate arrangement to provide a pressurized flow of cooling fluid to the appropriate cooling flow inlet(s), and may include a pump, a pressurized fluid source (e.g., a pressurized tank of liquid or gas cooling fluid), or any other appropriate source of cooling fluid. Additionally, the first cooling channel 222A may be configured to permit the first cooling flow 240A to exit the cooling module 126 via a first cooling flow outlet 244A, while the second cooling channel 222B may be configured to permit the second cooling flow 240B to exit the cooling module 126 via a second cooling flow outlet 244B.

In some embodiments, a cooling flow inlet 242A/242B may be located in an area near the beam block 218 to take advantage of a greater difference in temperature between the incoming cooling flow and a warmer area of the heat sink 220 surrounding the beam block 218. For example, the first cooling flow inlet 242A and the second cooling flow inlet 242B may each be disposed at the same end portion as the beam block 218 as shown. In the embodiment shown, the beam block 218 and the cooling flow inlets 242A, 242B may be disposed in the distal end portion of the cooling module 126, although it will be appreciated that one or more of these components may be disposed in a proximal end portion, a middle portion, or any other appropriate portion of a cooling module 126.

Further to the above, a heat sink 220 and/or a beam block 218 may be retained within a cooling module 216 housing using processes, components, and/or materials which may not require the generation of particulate matter, or which may limit the generation of particulate matter. In some embodiments, one or more components may be configured to provide an interface between the heat sink 220 and/or beam block 218 and the housing 221. For example, some embodiments may include a first seal 234A configured to form a first gas tight seal at a proximal end portion of the cooling module, and a second seal 234B configured to form a second gas tight seal at a distal end portion. In various embodiments, each seal 234A, 234B may comprise an O-ring, a gasket, or other resilient component extending around a perimeter or circumference of the heat sink 220, or around an interior transverse dimension (e.g., an inner diameter) of the cooling module housing 221. In some embodiments, each seal 234A, 234B may be in compressive contact between the heat sink 220 and the housing 2221. Further, in some embodiments, each seal 234A, 234B may be disposed in a respective channel 236A, 236B, which may be sized and shaped to receive the seal. In various embodiments, a channel may 236A/236B be formed in an exterior surface of the heat sink 220 and/or an interior surface of the housing 221. In some embodiments, a first channel 236A may be formed in the heat sink 220, and a second channel 236B may be formed in the cooling module housing 221. Further, in some embodiments, in order to prevent or reduce the generation of particulate matter which may result from the heat sink 220 contacting and dragging across an interior surface of the cooling module housing 221, an end of the heat sink 220 having a seal 234A (e.g., a seal disposed in a channel 236A as shown) may be inserted into the housing 221 first, such that the seal 234A may provide slidable, non-abrasive contact between the heat sink 220 and the housing 221.

Further, in some embodiments, each seal 234A, 234B may be configured to maintain a spacing between the heat sink 220 and the housing 221. In this regard, the spacing may permit the heat sink 220 to be translated and/or rotated into a desired position and/or orientation relative to the housing 221 without requiring contact between the heat sink/beam block 220/218 and the housing 221. In some embodiments, a maximum outer transverse dimension of the heat sink/beam block 220/218 (e.g., an outer diameter, width, etc.) may be less than a minimum inner transverse dimension of the cooling module housing 221 (e.g., an inner diameter, width, etc.). Further, in embodiments which include one or more fins 232A, 232B or other feature extending outwardly from the heat sink 220, the fin(s) 232A, 232B or other feature(s) may include a maximum outer transverse dimension that is less than the minimum inner transverse dimension of the housing 221. This spacing may prevent or reduce contact between the heat sink 220 and the housing 221 and the consequent generation of particulate matter during assembly of the cooling module 126. For example, in some embodiments, the seals 234A, 234B may be configured to maintain a spacing between the heat sink 220 and the cooling module housing 221. The seals 234A, 234B may further be configured allow the heat sink 220 to slide against the seals rather than against the cooling module housing 221. Thus, because the seals 234A, 234B may comprise a relatively soft material (e.g., an elastomer, a polymer, or others as noted above), the sliding engagement of the heat sink 220 with the seals 234A, 234B may reduce or eliminate the generation of particulate matter that may otherwise result from movement of the heat sink 220 against the housing 221. Additionally, in order to prevent cooling fluid from escaping the cooling channels 222A, 222B, each seal 234A, 234B may be configured to form a fluid-tight seal between the heat sink 220 and the cooling module housing 221.

Additionally, in some embodiments, the heat sink/beam block 220/218 may be retained in the desired position and/or orientation using an adhesive material, which may be a low off-gassing adhesive material. Accordingly, in some embodiments, a heat sink 220, beam block 218, and/or housing 221 may be configured to facilitate application of an adhesive to retain the heat sink 220 and/or beam block 218 within the cooling module 126. For example, in some embodiments, a heat sink 220 may include a chamfer, fillet, curvature, taper, or other surface geometry to facilitate deposition and/or flow of the adhesive into a desired location between the heat sink/beam block 220/218 and the housing 221. For example, each end portion of the heat sink 220 may include a surface geometry (e.g., a chamfer) configured to cooperatively form a respective channel 237 with the cooling module housing 221, each channel configured to receive an adhesive material therein.

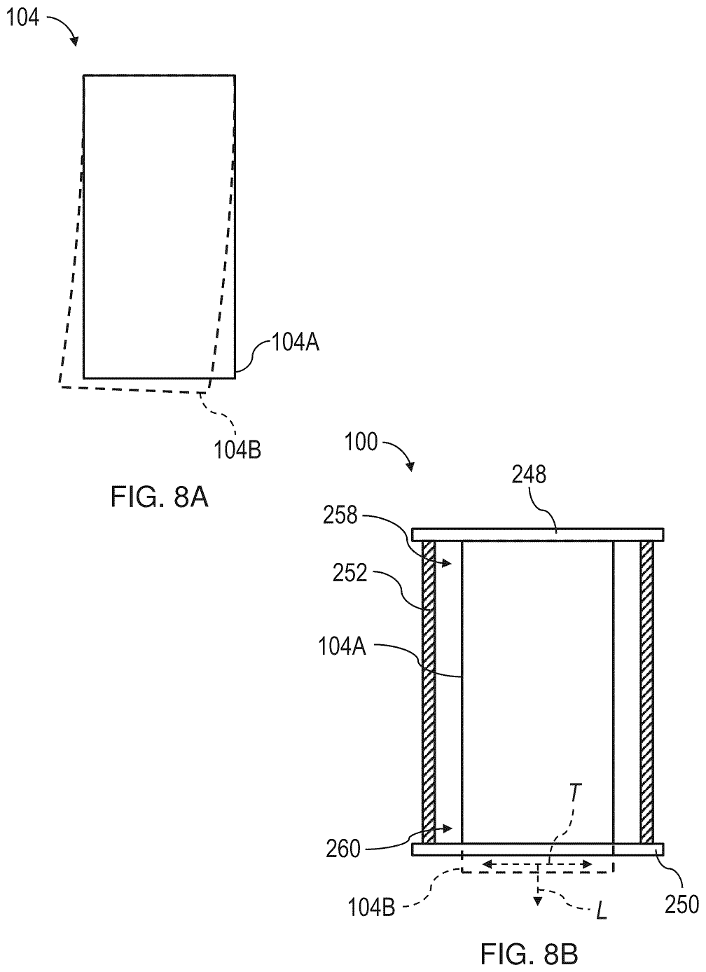

FIG. 8A depicts thermally-induced bending of an optics assembly 104. As discussed above, heating of an optics assembly 104 and the consequent thermal expansion of the optics assembly materials may cause the optics assembly 104 to expand from a non-expanded shape 104A to an expanded shape 104B. In some applications, asymmetric heating of the optics assembly 104 may cause expansion from a non-expanded shape 104A in which the optical component(s) of the optics assembly 104 may be in a desired position and/or alignment, to an expanded shape 104B which may be bent along its length such that one or more optical component(s) within the optics assembly 104 may be out of a desired position and/or alignment. Such an effect may be exacerbated by the use of supports and struts that are axially fixed at multiple locations along a length of the optics assembly 104 either due to different heating of the materials, different thermal expansion coefficients, and/or other considerations which may result in thermally induced stresses being applied to the optics assembly 104.

In view of the above, the inventors have recognized the benefits associated with the use of supports that are configured to permit relative movement of one or more supports and the optics assembly 104 in an axial direction due to thermal expansion. FIG. 8B depicts an optics assembly 104 configured to resist the thermal bending of FIG. 8A. In some embodiments, an optics assembly 104 may include a support 248 that is fixed relative to a first portion of the optics assembly 104 in both an axial direction (e.g., along a longitudinal axis) and transverse direction (e.g., a radial direction or other direction perpendicular to the longitudinal axis) of the optics assembly 104. As elaborated on further below, a second support 250 may also be affixed to a second portion of the optics assembly 104 at a location distal from the first portion. The second support 250 may be configured to resist transverse movement of the optics assembly 104 relative to the second portion while permitting axial movement of the second portion as elaborated on further below. Constraining the second portion of the optics assembly 104 relative to the first portion in this manner may help to resist deflection and/or bending of the optics assembly 104 in the transverse direction T.

In the embodiment shown, a first support 248 may be attached to a proximal portion 258 of the optics assembly 104, a second support 250 may be attached to a distal portion 260, and the first and second supports may be attached by two or more struts 252 extending between the first and second supports. For example, the two or more struts 252 may be located on opposing sides of a plane bisecting the optics assembly 104 along a longitudinal axis of the optics assembly 104. In some embodiments, the first support 248 may be fixed to the proximal portion 258 of the optics assembly, such that the first support may be constrained relative to the proximal portion 258 in both a transverse direction T and a longitudinal direction L. Thus, if the proximal portion 258 undergoes deflection in either the transverse direction T or the longitudinal direction L (e.g., as a result of thermal expansion), then the first support 248 may be deflected with the proximal portion 258. Further, in some embodiments, the struts 252 may be formed from a rigid material, such that the first and second supports 248, 250 may be fixed relative to one another (i.e., constrained in both the transverse and longitudinal directions). In some embodiments, the second support 250 may be attached to the distal portion 260 such that the distal portion 260 and the second support 250 may be free to move relative to one another in at least one direction. For example, the distal portion 260 may be constrained relative to the second support 250 in the transverse direction T while permitting relative movement of the distal portion 260 in the longitudinal direction L (which may be parallel to a longitudinal axis of the optics assembly 104). Such uni-directional constraint between the second support 250 and the distal portion 260 of the optics assembly, in combination with the constraint of the second support 250 relative to the proximal portion 258 in the longitudinal and transverse directions by virtue of the fixed first support 248 and the rigid struts 252, may resist the deflection of the distal portion 260 in the transverse direction T while permitting expansion of the distal portion 260 of the optics assembly 100 in the unconstrained longitudinal direction L relative to the proximal portion 258. Thus, in the embodiment shown, the distal portion 260 may undergo deflection in the longitudinal direction L, but may be constrained from deflecting in the transverse direction T, as shown by the expanded configuration 104B. Such an arrangement may also help to reduce the introduction of thermally induced stresses in the optics assembly 104.

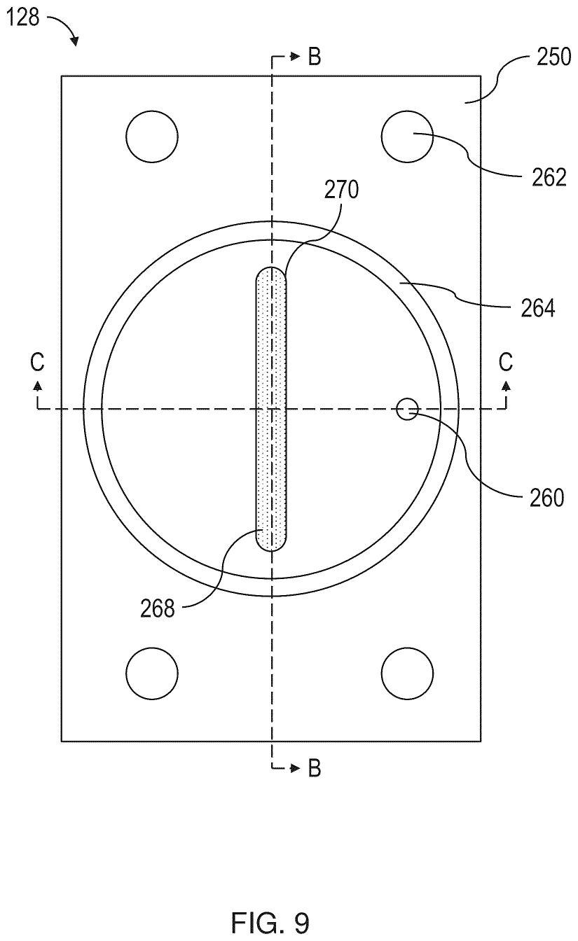

In some embodiments, a first or second support 248/250 may optionally be incorporated into a module of an optics assembly 104. For example, as shown in FIG. 9, a second support 250 may be included in an optics shield module 128. In some embodiments, the second support 250 may be formed as a plate of the optics shield module 128, the plate having two or more strut mounts 262. A strut mount 262 may comprise any appropriate arrangement for attaching a strut 252 to a support, including a recess configured to receive a portion of the strut 252, a threaded recess configured to threadably engage with a threaded portion of the strut 252, a bore configured to receive a fastener to secure the strut 252 to the support, and/or any other appropriate arrangement for attaching a strut to a support as the disclosure is not limited in this regard.

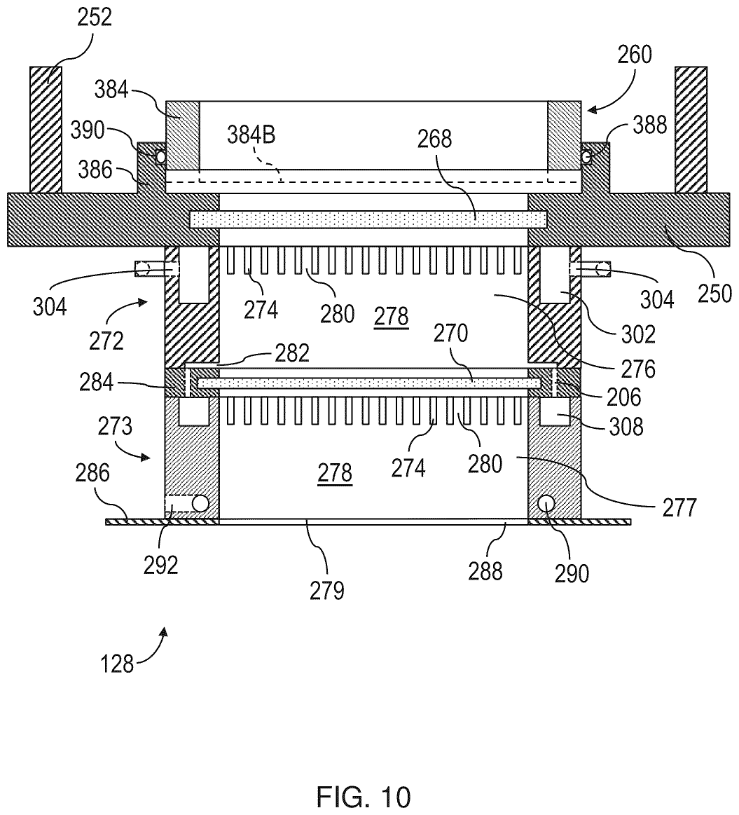

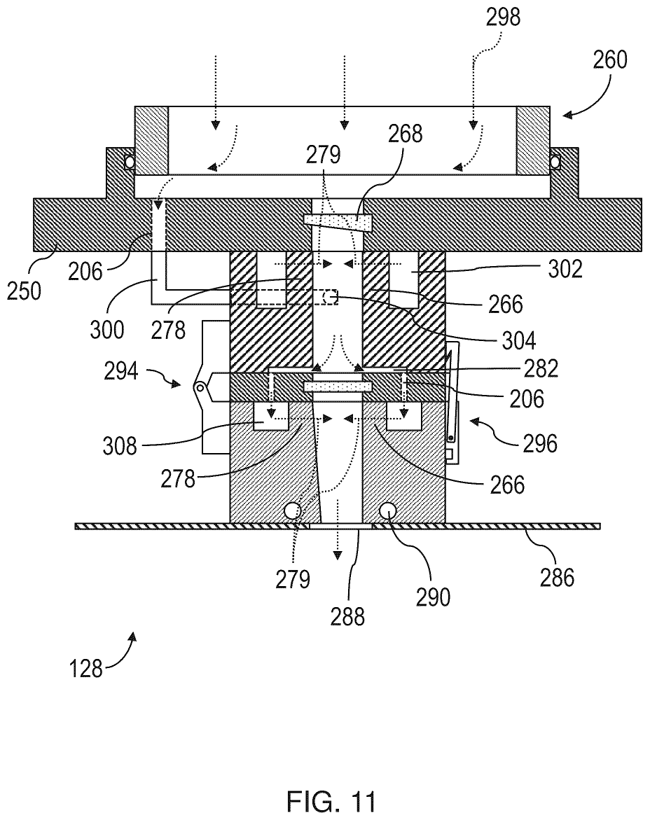

The second support 250 may further be configured to attach to an adjacent module or other portion of an optics assembly. For example, in some embodiments, an optics shield module 128 or a second support 250 thereof may include a receptacle 264 configured to engage with an adjacent module. For example, as shown in FIGS. 10-11, a portion of a second support 250 may be configured to receive a portion of an optics assembly 104 or a module thereof. For example, a housing 384 of a distal portion 260 of an optics assembly 104 (or a portion of the housing 384) may be configured to be inserted into a receptacle 386 of the second support 250. The housing 384 may be retained in the receptacle 386 such that the housing 384 may be permitted to expand in a longitudinal direction without expanding in a transverse direction, as discussed above. For example, the housing 384 may be retained in the receptacle 386 such that the housing 384 may be permitted to expand to an expanded configuration 384B. In some embodiments, the receptacle 386 may be configured to extend around an outer dimension of the distal portion 260 (e.g., an outer diameter or other transverse dimension), and may be configured to form a slidable seal with an outer surface of the housing 384. In some embodiments, the housing 384 may be retained in the receptacle 386 using a seal 388. In various embodiments, the seal 388 may comprise an O-ring, a gasket, or other resilient component extending around an internal perimeter or circumference of the receptacle 386. The seal 388 may be in compressive contact between the housing 384 and the receptacle 386, and may permit the housing 384 to expand in the longitudinal direction relative to the receptacle 386 (which may be held in place longitudinally by the struts 252). Further, in some embodiments, the seal 388 may be disposed in a channel 390 of the receptacle 386. In this regard, at least one of the housing 384 and the receptacle 386 may include a channel 390 sized and shaped to receive a seal 388.

Further to the above, in some embodiments, an optics shield module 128 may include one or more optical components. For example, as seen in FIGS. 9-11, the optics shield module 128 may include a deflection optical component 268 disposed within an aperture 270 of the optics shield module 128. The deflection optical component 268 may be configured to offset the laser beam(s) prior to incidence on the build surface, and/or to adjust an incident angle of the laser beam(s) on the build surface, and the aperture 270 may be configured to allow the laser beam(s) to pass through the optics shield module 128.

In some embodiments, the optics shield module 128 may further include one or more components configured to inhibit particulate matter from entering the optics assembly 104 or an optical space thereof. For example, as shown in FIGS. 10-11, the optics shield module 128 may include a debris shield 170 configured to inhibit particulate matter (e.g., ejecta and/or other particles from the build surface) from entering the optics assembly 104. In some embodiments, the debris shield 270 may be disposed along a beam path through the optics shield module 128. In some embodiments, a debris shield 270 may be an optically transparent component configured to allow laser energy to pass therethrough. Further, in some embodiments, a debris shield 270 may be removable and/or replaceable, such that the debris shield 270 may be replaced when a threshold amount of particulate matter has deposited thereon.

Further to the above, in some embodiments, an optics shield module 128 may include a nozzle assembly configured to direct a flow of gas away from one or more optical components of the optics shield module 128 and/or of the optics assembly 104. In some embodiments, the optics shield module 128 may be configured to receive a flow of gas from an adjacent module of the optics assembly 104, or from a gas flow source external to the optics assembly 104, and the nozzle assembly may be configured to receive the flow of gas. For example, the receptacle 386 of the optics shield module 128 may be configured to receive a flow of gas 298 from an adjacent module of the optics assembly. The optics shield module 128 may further include one or more bypass channels 206 configured to allow the flow of gas to pass by the deflection optic 268 and into the nozzle assembly.

In some embodiments, a nozzle assembly may include a first nozzle portion 272, a second nozzle portion 273, and an intermediate portion 284. In some embodiments, the first nozzle portion 272 may be configured to receive the flow of gas from the one or more bypass channels 206, and may be configured to provide localized entrainment to the deflection optic 268. For example, in some embodiments, a first nozzle portion 272 may include a first gas flow passage 276 extending distally from an area adjacent to the deflection optic 268. The intermediate portion 284 may be configured to retain a debris shield 270, for example by including a debris shield mount (which may be similar to the optics mounts described herein, or may be any other appropriate arrangement for mounting the debris shield 270 within the intermediate portion 284). The intermediate portion 284 may further include one or more bypass channels 206 configured to allow the flow of gas to flow around the debris shield 270, and may be configured to fluidly couple the first and second nozzle portions 272, 273. The second nozzle portion 273 may be configured to receive the flow of gas from the first nozzle portion 272 via one or more bypass channels 206, and may be configured to provide localized entrainment to the debris shield 270. For example, in some embodiments, the second nozzle portion 273 may include a second gas flow passage 277 extending distally from an area adjacent to the debris shield 270. Further, the second nozzle portion 273 may include a gas flow outlet 279 at a distal end of the second gas flow passage 277, and the gas flow outlet 279 and/or the second gas flow passage 277 may be configured to direct the flow of gas out of the optics assembly 104.

In some embodiments, an entrance of a gas flow passage may include one or more gas flow passage inlets 274. In various embodiments, a gas flow passage inlet may be formed in any appropriate construction, including a through-hole extending through a wall of the entrance, a slot in a wall, a protrusion extending from a wall, or any other appropriate structure or configuration that defines a gap through which a flow of gas may enter the gas flow passage. In some embodiments, a plurality of gas flow passage inlets 274 may be formed as a series of gaps in a wall. For example, each of the first and second nozzle portions 272, 273 may include a respective first wall section 266 and a respective second wall section 278 disposed on opposing sides of the respective gas flow passages 276, 277. Further, in some embodiments, each of the first and second wall sections 266, 278 may include a group of crenellations 280 formed at a proximal end thereof. A group gas flow passage inlets 274 may be formed between the crenellations 280, and may be configured to allow a flow of gas to enter the associated gas flow passage between the crenellations 280. Thus, in some embodiments, a nozzle portion may include a plurality of gas flow passage inlets 274 comprising a first group of gas flow passage inlets disposed along the first wall section 266 of the associated gas flow passage, and a second group of nozzles disposed along a second wall section 278 opposite the first wall section. Each group may be formed by a respective plurality of crenellations 280 as shown in FIG. 10. FIG. 10 depicts only the second wall sections 278, each including a second group of gas flow passage inlets 274 formed by a second group of crenellations 280. However, it will be appreciated that each first wall section 266 (see FIG. 11) may be similarly arranged to include respective first groups of gas flow passage inlets 274 formed by respective first groups of crenellations 280. Thus, each wall section 266, 278 may have gas flow passage inlets 274 formed therein, such that the flow of gas may enter the gas flow passages 276, 277 via opposing entrance flows 279 through the opposing wall sections 266, 278 (see FIG. 11). In some embodiments, the first group of gas flow passage inlets 274 on the first wall section 266 may be offset from the second group of gas flow passage inlets on the second wall section 278, such that gas passing through an inlet 274 of the first group may be directed across the gas flow passage toward a crenellation 280 of the second group. This may allow the first and second groups of gas flow passage inlets to direct gas flow toward each other across the gas flow passage while reducing interference between their respective entrance flows 279. In embodiments where steady uniform flow is desired, this may facilitate steady uniform flow by reducing large scale turbulence and/or other unstable flow conditions which may result from interference between opposing gas flows. Furthermore, it should be appreciated that the gas flow passage inlets 274 may have any appropriate shape, contour, or curvature, including shapes configured to influence a flow of gas through the gas flow passage inlet or guide a flow of gas into the gas flow passage. For example, in some embodiments, each gas flow passage inlet 274 may be formed as a nozzle that converges or diverges in the direction of an entrance flow 279 to control an entrance velocity of the flow.

Further, in some embodiments, a nozzle portion 272/273 of an optics shield module may include a gas flow plenum configured to quiesce a flow of gas, for example by controlling or slowing a gas flow velocity. In some embodiments, a gas flow plenum may be located at a point along the flow of gas which is upstream from a gas flow passage, such that the gas flow plenum may facilitate a steady uniform flow condition at, near, or through an entrance of the gas flow passage, or to provide other gas flow characteristics.

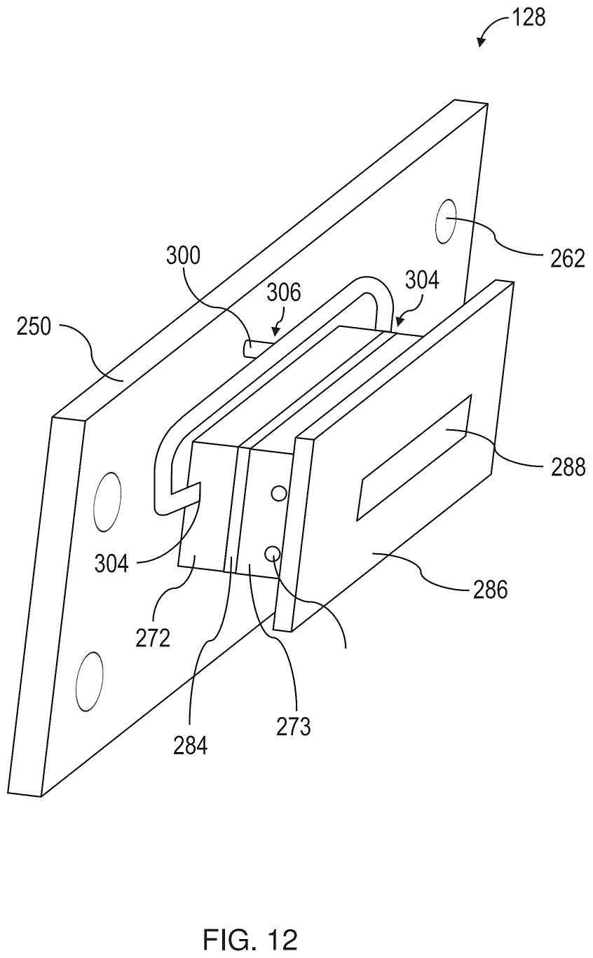

As best shown in FIG. 11, a flow of gas 298 may be received from a second portion 260 of the optics assembly, which may include an adjacent module of the optics assembly (e.g., an optics module, an interface module, a cooling module, etc.). In some embodiments, the gas flow 298 may pass through one or more bypass channels 206 formed in the optics shield module or a portion thereof (e.g., the second support 250). Although only one bypass channel is depicted, it will be appreciated that an optics shield module may include any appropriate number of bypass channels, including two, three, four, five, six, or more, as the disclosure is not particularly limited in this regard. Further, in some embodiments, the one or more bypass channel may be fluidly coupled to a gas flow line 300, which may be fluidly coupled to a first plenum 302 of the first nozzle portion 272. In some embodiments, the first plenum 302 may at least partially surround at least a portion the first gas flow passage 276 (e.g., a proximal end portion). In some embodiments, the gas flow line 300 may be in fluid communication with one or more first plenum inlets 304. For example, as best seen in FIG. 10, the first nozzle portion may include two first plenum inlets 304 at opposing ends of the first plenum. As best seen in FIG. 12, the gas flow line 300 may include a tee section 306 configured to bifurcate the flow of gas and/or to allow the flow of gas to enter each first plenum inlet 304. In some embodiments, a gas flow line may be any appropriate conduit for carrying a flow of gas, including a pipe, a tube, a duct, a hose, or any other appropriate arrangement, including conduits of any appropriate materials (e.g., metal, plastic, composite, etc.). Further, although the figures depict a gas flow line between the bypass channel 206 and the first plenum inlets, it should be appreciated that in other embodiments, bypass channel(s) may be coupled directly to the first plenum inlet(s), such that no gas flow line is included. In this regard, any appropriate arrangement may be used to allow a flow of gas from the bypass channel(s) into the first plenum, as the disclosure is not particularly limited in this regard.

The first plenum may be fluidly coupled to the first gas flow passage 276 via an entrance of the first gas flow passage. For example, the first plenum 302 may be coupled to first gas flow passage via a first group of gas flow passage inlets 274 formed in a first wall section of the first gas flow passage and a second group of gas flow passage inlets 274 formed in a second wall second of the first gas flow passage.

In some embodiments, the first and second nozzle portions may be fluidly coupled such that the flow of gas passes through the first gas flow passage and into the second gas flow passage. In some embodiments, the first nozzle portion 272 may include one or more first nozzle outlets configured to fluidly couple the nozzle portion to the second nozzle portion. For example, the first gas flow passage 272 may include one or more first nozzle outlets 282 formed as a channel, opening, or recess formed at a distal end of the first nozzle portion. Further, in some embodiments, a first gas flow outlet 282 may be fluidly coupled to a bypass channel 206 formed in an intermediate portion, such as the debris shield housing 284. The bypass channel(s) 206 may be fluidly coupled to the second plenum 308, which may be configured to quiesce the flow of gas at a point upstream from the second gas flow passage 273, for example to facilitate a steady uniform flow condition at, near, or through the entrance (e.g., the second plurality of gas flow passage inlets) of the second gas flow passage. The second plenum 308 may at least partially surround a portion of the second gas flow passage (e.g., a proximal end portion). As noted above, some such dual-plenum, dual-nozzle arrangements may provide localized entrainment benefits to each of a deflection optic and a debris shield.

In some embodiments, an optics shield module may include a heat shield configured to absorb heat and/or light energy reflected off of the build surface and/or the melt pool. For example, the optics shield module 128 may include a heat shield 286, which may be formed as a plate disposed at a distal end of the optics shield module. The heat shield 286 may further include an aperture 288 In some embodiments, a heat shield may be configured to absorb heat and/or light energy, for example by including an absorptive surface finish and/or surface treatment. For example, in some embodiments, the heat shield may include an optical black coating, anodized aluminum, or any other appropriate surface finish or surface treatment.

An optics shield module may further incorporate various forms of cooling to remove heat absorbed by the heat shield. In some embodiments, an optics shield module may include a cooling channel at a location adjacent to the heat shield. For example, the second gas flow passage 273 may include a cooling channel 290 formed in a wall portion thereof. In some embodiments, the cooling channel 290 may include a cooling channel inlet 292 configured to receive a cooling fluid from a fluid source. In various embodiments, the cooling fluid may be any appropriate cooling fluid, including water, a refrigerant, gas (e.g., air, or an inert gas such as argon or others), and/or any other fluid or combination of fluids.

In some embodiments, as noted above, a debris shield of an optics shield module may be configured to be removed and/or replaced. For example, as shown in the figures, a hinged connection 294 may connect the first nozzle portion 272 to the second nozzle portion 273. The hinged connection may cooperate with a clasp 296 configured to urge the second nozzle portion 273 toward the first nozzle portion 272. In some embodiments, an intermediate portion of the nozzle assembly (e.g., the debris shield housing 284) may be disposed between the first and second nozzle portions, such that a compressive force imparted by the clasp may press the debris shield housing between the first and second nozzle portions. In some embodiments, one or more resilient members (e.g., O-rings, gaskets, etc.; not pictured) may be included between the debris shield housing and the first and/or second nozzle portions in order to maintain a gas tight connection with the debris shield housing. In some embodiments, when replacement of the debris shield is desired (e.g., when a threshold amount of particulate matter and/or other contamination has deposited on the debris shield and/or when contamination begins to interfere with the beam quality), the clasp may be undone and the second gas nozzle portion 273 may be rotated away from the first nozzle portion to allow removal of the debris shield and debris shield housing. A new debris shield housing, including a new debris shield, may be positioned between the first and second nozzle portions, and the second nozzle portion may be rotated back into position against the new debris shield and the clasp closed to secure the nozzle assembly together.

Although the figures depict a support as being included in an optics shield module, it will be appreciated that a support may be incorporated into any other type of module as disclosed herein, and/or may be incorporated into an optics assembly as a standalone component or module as well.

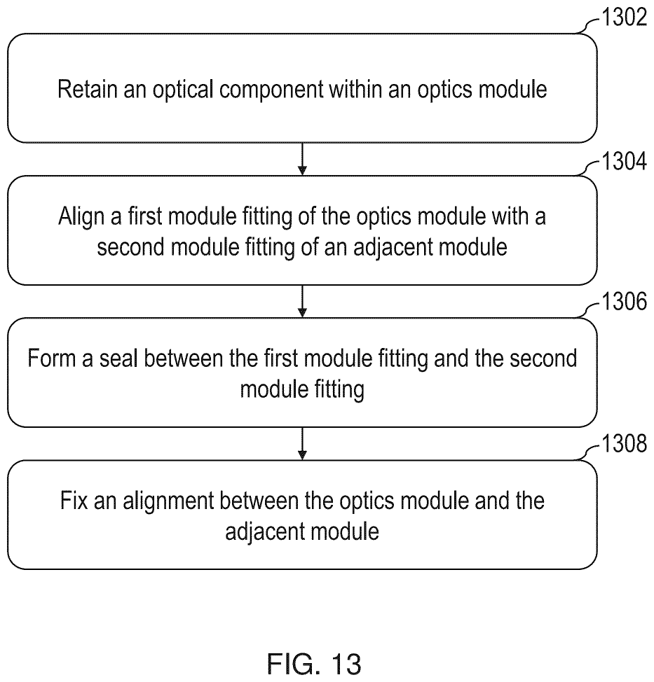

As shown in FIG. 13, a method of manufacturing an optics assembly may include retaining one or more optical components within an optics module. In some embodiments, retaining the optical component(s) within the optics module may include mounting the optical component(s) using an optics mount as described herein. For example, the optical component(s) may be positioned in relation to a reference feature, such as an optics shoulder. The optical component(s) may be placed in contact with the reference feature, and may in some embodiments be supported by the reference feature. For example, in some embodiments, one or more optical components may be placed in an optics recess of an optics mount, and/or on an optics shoulder such that the optics recess and/or the optics shoulder support(s) the optical component(s) in a desired position, location, and/or orientation. In some embodiments, retaining the one or more optical components may further include pressing the optical component(s) against the reference feature. For example, a retaining component, such as a retaining plate as described herein, may be pressed against the optical component(s) and secured in place. In some embodiments, the retaining component (e.g., retaining plate) may be secured using an adhesive material, for example by depositing the adhesive material into a channel formed between the retaining component and a retaining recess in which the retaining component is disposed. Further, in some such embodiments, the adhesive may be deposited into one or more wells formed in the channel.

In some embodiments, retaining the optical component(s) may include placing one or more resilient members between the optical component(s) and the retaining component (e.g., retaining plate). For example, some embodiments may include placing an O-ring, a gasket, or another resilient member between the optical component(s) and the retaining plate. Further, in some such embodiments, retaining the optical component(s) may further include placing a reflective shield between the resilient member(s) and the optical component(s), for example to inhibit interaction of stray light with the resilient member(s). In some embodiments, placing the reflective shield may include enclosing the resilient member(s), for example by placing the reflective shield in contact with at least one of the retaining component(s) and the optics recess to enclose the resilient member(s). In some embodiments, enclosing the resilient member(s) may include completely enclosing the resilient member(s).

At step 1304, according to some embodiments, manufacturing an optics assembly may further include aligning a first module fitting of the optics module with a second module fitting of an adjacent module. In some embodiments, aligning the module fittings may include translating and/or rotating at least one of the optics module and the adjacent module relative to the other of the optics module and the adjacent module to place the optics module in a desired pose (i.e., position and/or orientation) relative to the adjacent module. For example, in some embodiments, aligning the module fittings may include translating one of the optics module and the adjacent module in a longitudinal direction and/or a transverse direction (e.g., a radial direction) relative to the other. Additionally or alternatively, in some embodiments, aligning the module fittings may include rotating one of the optics module and the adjacent module relative to the other.

Additionally or alternatively, in some embodiments, aligning the module fittings may include rotating at least one of the optics module and the adjacent module about a longitudinal axis of the optics module and/or the adjacent module. Further, in some such embodiments, aligning the module fittings may include directing light energy (e.g., a laser beam) through the optics module and the adjacent module while rotating the optics module and the adjacent module about the longitudinal axis. Such methods may further include evaluating an eccentricity of a path of incidence of the laser beam on a calibration surface, and translating at least one of the one of the optics module and the adjacent module in a longitudinal direction and/or a transverse direction (e.g., a radial direction) relative to the other to achieve a desired eccentricity. In some such embodiments, the adjacent module may be a second optics module having at least a second optical component retained therein. Additionally or alternatively, the adjacent module may be joined to a second optics module having at least a second optical component retained therein.

Further to the above, aligning the first module fitting with the second module fitting may further include inserting a portion of one fitting into a portion of the other fitting. For example, a portion of the first module fitting may be inserted into a portion of the second module fitting, and/or a portion of the second module fitting may be inserted into a portion of the first module fitting. In some such embodiments, a tongue of the first module fitting may be inserted into a groove of the second module fitting. In some embodiments, a collar of the second module fitting may be inserted into a receptacle of the first module fitting.

At step 1306, some methods may further include forming a seal between the first module fitting and second module fitting. In some embodiments, forming the seal may include forming a gas-tight intermodular seal between the first and second module fittings. For example, in some embodiments, forming the seal may include depositing an adhesive material between the first and second module fittings. In some embodiments, depositing an adhesive material may include depositing the adhesive material into a groove of the second module fitting. In some embodiments, forming the seal may include compressing a resilient member between the first module fitting and the second module fitting, for example between a receptacle of the first module fitting and a collar of the second module fitting. Additionally or alternatively, in some embodiments, forming the seal may include fastening the first and second module fittings together, for example using a threaded fastener or other fastener. In some such embodiments, inserting the fastener may include inserting the fastener into an area outside of an optical space of the optics module, the adjacent module, and/or the optics assembly. For example, in some embodiments, the fastener may be inserted into an area located outwardly relative to the seal. In some methods in which an adhesive material is used, the alignment processes described herein (e.g., step 1304) may be performed after the adhesive is deposited and/or while the adhesive is drying, setting, hardening, or otherwise solidifying to retain the module fittings in their relative positions, although embodiments in which the aligning step is performed before the adhesive is deposited are also contemplated.

At step 1308, some methods may further include fixing an alignment between the optics module and the adjacent module. In some embodiments, fixing the alignment may include depositing an adhesive material between the first and second module fittings, as discussed above with reference to step 1306. In some embodiments, depositing an adhesive material may include depositing the adhesive material into a groove of the second module fitting. In some embodiments, fixing the alignment may include compressing a resilient member between the first module fitting and the second module fitting, for example between a receptacle of the first module fitting and a collar of the second module fitting. Additionally or alternatively, in some embodiments, fixing the alignment may include fastening the first and second module fittings together, for example using a threaded fastener or other fastener. In some such embodiments, inserting the fastener may include inserting the fastener into an area outside of an optical space of the optics module, the adjacent module, and/or the optics assembly. For example, in some embodiments, the fastener may be inserted into an area located outwardly relative to the seal. It will be appreciated from the foregoing that in some embodiments, fixing the alignment and forming the seal may be performed simultaneously and/or through the same process step(s). For example, depositing the adhesive material and/or allowing the adhesive to cure as discussed above may both fix the alignment and form the seal. However, it will also be appreciated that fixing the alignment and forming the seal may be performed separately, at different times, and/or through different processes, as the disclosure is not limited to embodiments in which fixing the alignment and forming the seal are accomplished concurrently or through the same process steps.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are provided by way of example only.

1. An optics assembly for an additive manufacturing system, the optics assembly comprising:
an optical fiber module, wherein at least one optical fiber is disposed within the optical fiber module, the optical fiber module having a gas flow inlet configured to receive a flow of gas;
at least one optics module, each optics module comprising an optics module housing and at least one optical component disposed in the optics module housing, each optical component configured to interact with at least one laser beam from the at least one optical fiber as the at least one laser beam passes through the optics assembly;
an optics shield module having a gas flow outlet; and
a gas flow path extending from the gas flow inlet of the optical fiber module to the gas flow outlet of the optics shield module, the gas flow path configured to allow the flow of gas to pass through each of the optical fiber module, the optics shield module, and each optics module of the at least one optics module.

2. The optics assembly of claim 1, further comprising at least one gas filter fluidly coupled to the gas flow inlet, the at least one gas filter configured to remove particulate matter from the flow of gas when the flow of gas flows through the gas flow inlet

3. The optics assembly of claim 1, further comprising at least one gas-tight intermodular seal, the at least one gas-tight intermodular seal configured to seal a first one of the optical fiber module, an optics module of the at least one optics module, and the optics shield module with a second one of the optical fiber module, the optics module of the at least one optics module, and the optics shield module to inhibit particulate matter from entering the optics assembly, wherein the at least one gas-tight intermodular seal comprises a first gas-tight seal between the optics module and a cooling module of the optics assembly, the first gas-tight seal surrounding a portion of the gas flow path to inhibit particulate matter from entering the optics assembly.

4. (canceled)

5. The optics assembly of claim 3, wherein the first gas-tight seal is formed between a groove of the optics module and a tongue of the cooling module, the tongue inserted into the groove and retained within the groove by an adhesive material, wherein the tongue extends around a peripheral area of a proximal end portion of the cooling module, and wherein the groove extends around a peripheral area of a distal end portion of the optics module.

6.-7. (canceled)

8. The optics assembly of claim 1, further comprising a cooling module, the cooling module comprising a cooling module housing, wherein an interior surface of the cooling module housing is configured to absorb at least one of light energy and heat energy.

9. The optics assembly of claim 1, wherein at least a portion of one or more optics modules of the at least one optics module is configured to cause recirculation of the flow of gas at a point along the gas flow path upstream from the at least one optical component, and wherein the recirculation of the flow of gas is configured to cool the at least one optical component.

10. (canceled)

11. The optics assembly of claim 1, wherein each optics module of the at least one optics module includes at least one optical component retained within the optics module by an optics mount, the optics mount including one or more bypass channels to allow gas flow around the at least one optical component, and wherein the one or more bypass channels comprises a plurality of bypass channels disposed radially outwardly from the optical component.

12. (canceled)

13. The optics assembly of claim 1, wherein the optical fiber module is disposed at a proximal end portion of the optics module and the optics shield module is attached to a distal end portion of the optics module, the optics assembly further comprising a cooling module disposed between the optical fiber module and the optics shield module.

14. (canceled)

15. The optics assembly of claim 1, further comprising an interface module disposed between the optical fiber module and the optics module, the gas flow path extending through the interface module, the interface module configured to form a first gas-tight seal with the optical fiber module and a second gas-tight seal with an optics module of the at least one optics module, each of the first and second gas-tight seals surrounding a portion of the gas flow path to inhibit particulate matter from entering the gas flow path.

16. The optics assembly of claim 15, wherein the first gas-tight seal is formed between a tongue of the optics module and a groove of the interface module, wherein the tongue is inserted into and retained within the groove, and wherein the tongue extends around a peripheral area of a proximal end portion of the optics module, and wherein the groove extends around a peripheral area of a distal end portion of the interface module.

17.-18. (canceled)

19. The optics assembly of claim 15, wherein the second gas-tight seal is formed between a collar of the interface module and a receptacle of the optical fiber module, the receptacle configured to receive at least a portion of the collar therein, and wherein the collar extends around a peripheral area of a proximal end portion of the interface module, and wherein the receptacle is disposed at a distal end portion of the optical fiber module, the receptacle having an inner surface, a channel formed in the inner surface, and a seal disposed in the channel, the seal in compressive contact with an exterior surface of the collar to form the second gas-tight seal around a portion of the gas flow path.

20. (canceled)

21. The optics assembly of claim 20, wherein the proximal end portion of the interface module further comprises a proximal flange, and the distal end portion of the optical fiber module further comprises a distal flange, the proximal flange and the distal flange joined by one or more threaded fasteners disposed radially outwardly from the seal, the seal configured to inhibit particulate matter from entering the gas flow path.

22. An additive manufacturing system including the optics assembly of claim 1, the additive manufacturing system further comprising:
one or more laser energy sources, each laser energy source optically coupled to a respective optical fiber of the at least one optical fiber, each laser energy source configured to direct laser energy to the optical fiber module via the respective optical fiber;
a build plate configured to receive a layer of precursor material; and
a recoater configured to deposit the layer of precursor material on the build plate,
wherein the optics assembly is configured to form at least one laser energy pixel on the layer of precursor material to fuse at least a portion of the layer of precursor material.

23. The optics assembly of claim 1, wherein the at least one optical fiber comprises a plurality of optical fibers, each optical fiber of the plurality of optical fibers operatively connected to a respective laser energy source.

24. A method for additive manufacturing, the method comprising:
directing a flow of gas into an optical fiber module of an optics assembly, the optical fiber module comprising at least one optical fiber configured to produce at least one laser beam;
directing the flow of gas into at least one optics module of the optics assembly, each optics module of the at least one optics module comprising at least one optical component disposed within the optics module, the at least one optical component configured to interact with at least one laser beam from the at least one optical fiber as the at least one laser beam passes through the optics assembly;
directing the flow of gas around each optical component of the at least one optical component;
directing the flow of gas into an optics shield module of the optics assembly, the optics shield module comprising a debris shield configured to inhibit particulate matter from entering the optics assembly;
directing the flow of gas around the debris shield; and
directing the flow of gas out of the optics shield module towards a build surface of an additive manufacturing system.

25. The method of claim 24, further comprising removing one or more contaminants from the optics assembly using the flow of gas.

26. The method of claim 24, wherein directing the flow of gas into the optical fiber module comprises filtering the flow of gas to remove particulate matter from the flow of gas.

27. The method of claim 24, further comprising depositing a layer of precursor material on the build surface, directing at least one laser beam through the optics assembly towards the build surface, and fusing at least a portion of the layer of precursor material with the at least one laser beam.

28. The method of claim 24, further comprising inhibiting particulate matter from entering the optics assembly using at least one gas-tight intermodular seal between a first one of the optical fiber module, an optics module of the at least one optics module, and the optics shield module and a second one of the optical fiber module, the optics module of the at least one optics module, and the optics shield module

29. The method of claim 28, wherein the at least one gas-tight intermodular seal comprises a first gas-tight seal between the optics module and a cooling module of the optics assembly, the first gas-tight seal surrounding a portion of the gas flow path to inhibit particulate matter from entering the optics assembly.

30. The method of claim 29, wherein the first gas-tight seal is formed between a groove of the optics module and a tongue of the cooling module, the tongue inserted into the groove and retained within the groove by an adhesive material, and wherein the tongue extends around a peripheral area of a proximal end portion of the cooling module, and wherein the groove extends around a peripheral area of a distal end portion of the optics module.

31.-32. (canceled)

33. The method of claim 24, further comprising, for one or more optics modules of the at least one optics module, recirculating the flow of gas at a point upstream from the at least one optical component, wherein recirculating the flow of gas comprises cooling the at least one optical component.

34. (canceled)

35. The method of claim 24, wherein directing the flow of gas around the at least one optical component comprises directing the flow of gas through one or more bypass channels formed in an optics mount in which the at least one optical component is retained, wherein the one or more bypass channels comprises a plurality of bypass channels disposed radially outwardly from the optical component.

36. (canceled)

37. The method of claim 24, wherein the optical fiber module is disposed at a proximal end portion of the optics module and the optics shield module is attached to a distal end portion of the optics module, the method further comprising at least one of: directing the flow of gas into a cooling module disposed between the optical fiber module and the optics shield module, and absorbing stray light energy in a heat sink of the cooling module.

38.-39. (canceled)

40. The method of claim 24, further comprising flowing the flow of gas into an interface module disposed between the optical fiber module and the optics module, and inhibiting particulate matter from entering the gas flow path using a first gas-tight seal formed between the optical fiber module and the interface module and a second gas-tight seal formed between an optics module of the at least one optics module and the interface module.

41. The method of claim 40, wherein the first gas-tight seal is formed between a tongue of the optics module and a groove of the interface module, wherein the tongue is inserted into and retained within the groove.

42. The method of claim 41, wherein the tongue extends around a peripheral area of a proximal end portion of the optics module, and wherein the groove extends around a peripheral area of a distal end portion of the interface module.

43. (canceled)

44. The method of claim 40, wherein the second gas-tight seal is formed between a collar of the interface module and a receptacle of the optical fiber module, the receptacle configured to receive at least a portion of the collar therein, wherein the collar extends around a peripheral area of a proximal end portion of the interface module, and wherein the receptacle is disposed at a distal end portion of the optical fiber module, the receptacle having an inner surface, a channel formed in the inner surface, and a seal disposed in the channel, the seal in compressive contact with an exterior surface of the collar to form the second gas-tight seal around a portion of the gas flow path.

45. (canceled)

46. The method of claim 45, wherein the proximal end portion of the interface module further comprises a proximal flange, and the distal end portion of the optical fiber module further comprises a distal flange, the proximal flange and the distal flange joined by one or more threaded fasteners disposed radially outwardly from the seal, the seal configured to inhibit particulate matter from entering the gas flow path.

47. The method of claim 24, wherein the at least one optical fiber comprises a plurality of optical fibers, each optical fiber of the plurality of optical fibers operatively connected to a respective laser energy source.

48. The method according to claim 24, further comprising fusing a precursor material on the build surface using the at least one laser beam to form one or more parts on the build surface.

49.-191. (canceled)
